(19) United States
(12) Patent Application Publication
(10) Pub. No.: US 2012/0019757 A1
(43) Pub. Date: Jan. 26, 2012

(54) LIQUID CRYSTAL DISPLAY DEVICE

(75) Inventors: Fumikazu Shimoshikiryoh, Osaka (JP); Akihiro Shohraku, Osaka (JP); Yuki Yamashita, Osaka (JP); Akane Sugisaka, Osaka (JP); Masahiro Yoshida, Osaka (JP); Takahiro Sasaki, Osaka (JP)

(73) Assignee: Sharp Kabushiki Kaisha, Osaka (JP)

(21) Appl. No.: 13/259,845

(22) PCT Filed: Apr. 1, 2010
(86) PCT No.: PCT/JP2010/002404

§ 371 Date: Sep. 23, 2011

(30) Foreign Application Priority Data
Apr. 3, 2009 (JP) 2009-091130

(51) Int. Cl. G02F 1/1337

(52) U.S. Cl. 349/129

(57) ABSTRACT

The MVA liquid crystal display device of the present invention includes a first domain regulating structure formed in a first substrate and a second domain regulating structure formed in a second substrate. The first domain regulating structure includes a first linear component extending in a first direction and a second linear component extending in a second direction different from the first direction by about 90°. The second domain regulating structure includes a third linear component extending in the first direction, and a fourth linear component extending in the second direction. When a voltage is applied across a liquid crystal layer, four domains in which the tilt directions of liquid crystal molecules are mutually different by about 90° are formed. An arbitrary pixel includes at least one first electrode formed in the first substrate and a second electrode formed in the second substrate. Each of the at least one first electrode has a continuous opening pattern, and the first and second linear components of the first domain regulating structure are included in any of the continuous opening patterns included respectively in the at least one of first electrode. According to the MVA liquid crystal display device of the present invention, restoration can easily be performed.

### TECHNICAL FIELD

The present invention relates to a liquid crystal display device, and more particularly to an MVA liquid crystal display device.

### BACKGROUND ART

MVA (Multidomain Vertical Alignment) liquid crystal display devices have wider viewing angle performance than TN liquid crystal display devices, so that MVA liquid crystal display devices are widely used as liquid crystal display devices for TV and other applications (see Patent Documents 1 and 2, for example).

In the MVA liquid crystal display device, on the sides facing a vertical alignment liquid crystal layer of a pair of substrates which are opposed with the liquid crystal layer interposed therebetween, domain regulating structures (also referred to as orientation regulating structures) are disposed, so as to form a plurality of liquid crystal domains having different orientations (tilt directions) of directors. As the domain regulating structure, an opening portion (a slit) provided in an electrode, or a dielectric protrusion (a rib) formed on the side facing the liquid crystal layer of the electrode is used.

Typically, the pair of substrates are respectively provided with linear domain regulating structures extending in two directions which are mutually orthogonal. When they are viewed from a direction perpendicular to the substrates, the domain regulating structure formed on one substrate and the domain regulating structure formed on the other substrate are arranged in parallel and alternately. As a result, when a voltage is applied across a liquid crystal layer of an arbitrary pixel, four domains in which liquid crystal molecules which are tilted in directions mutually different by about 90° (also referred to as director directions of liquid crystal domains) are formed between the linear domain regulating means. Typically, four liquid crystal domains with their director azimuth angles of 45° with respect to polarization axes (transmission axes) of a pair of polarization plates disposed in a crossed-Nichole manner are formed. When 0° of azimuth angle is assumed as a direction of polarization axis of one polarization plate (e.g. a horizontal direction of a display plane), and the anticlockwise direction is assumed to be a positive direction, the azimuth angles of the directors of the four liquid crystal domains are 45°, 135°, 225°, and 315°.

The term “pixel” in the present specification indicates the minimum unit of the display performed by a liquid crystal display device. In the case of color display, the term “pixel” indicates the minimum unit for displaying each primary color (typically R, G, or B), and is sometimes referred to as “dot.”

In recent years, in order to improve the dependence on viewing angle of γ characteristic of MVA liquid crystal display device, in Patent Document 3, the applicant of the present invention discloses a liquid crystal display device and a driving method in which one pixel is divided into a plurality of sub-pixels having different degrees of brightness, thereby improving the dependence on viewing angle of the γ characteristic. Especially, it is possible to improve the dependence on viewing angle of the γ characteristic in which display luminance of lower gradation sequence is higher (whitish) than a predetermined luminance. In the present specification, such display or driving may sometimes be referred to as area-grayscale display, area-grayscale driving, multi-pixel display, multi-pixel driving, or the like.

Patent Document 3 discloses a liquid crystal display device in which a storage capacitor is provided for a plurality of sub-pixels in one pixel, storage capacitor counter electrode for constituting the storage capacitor (connected to a CS bus line) is electrically independent for each sub-pixel, and a voltage supplied to the storage capacitor counter electrode (referred to as a storage capacitor counter voltage) is varied, thereby varying effective voltages to be applied across liquid crystal layers of the plurality of sub-pixels by utilizing capacitance split. In applications requiring wide viewing angle performance such as for TV, the MVA liquid crystal display device adopts multi-pixel display by way of various methods.

The entire disclosures of Patent Documents Nos. 1 to 3 are hereby incorporated by reference.

### CITATION LIST

### Patent Literature

Patent Document 1: Japanese Laid-Open Patent Publication No. 11-242225 (U.S. Pat. No. 6,724,452)
Patent Document 2: Japanese Laid-Open Patent Publication No. 2000-155317 (U.S. Pat. No. 6,879,364)
Patent Document 3: Japanese Laid-Open patent Publication No. 2004-62146 (U.S. Pat. No. 6,958,791)

### SUMMARY OF INVENTION

### Technical Problem

As liquid crystal displays are widely spread, lower prices of liquid crystal display devices are increasingly required. Therefore, it is necessary to improve the yield of production of MVA display devices. For example, if any electrically conductive foreign material is mixed between a first electrode (e.g. a pixel electrode) and a second electrode (e.g. a counter electrode) which are opposed with a liquid crystal layer interposed therebetween, and the first electrode and the second electrode are electrically short-circuited, a voltage is not applied across the liquid crystal layer of the pixel. This causes a pixel defect.

The present invention has been conducted so as to improve the yield of production of MVA liquid crystal display devices, and the objective of the present invention is to provide an MVA liquid crystal display device having a configuration which can easily be restored.

### Solution to Problem

The MVA liquid crystal display device of the present invention is a liquid crystal display device including: a first substrate; a second substrate; a vertical-alignment type liquid crystal layer disposed between the first substrate and the second substrate; a first domain regulating structure formed in the first substrate; and a second domain regulating structure formed in the second substrate, the first domain regulating structure having a first linear component extending in a first direction and a second liner component extending in a second direction different from the first direction by about 90°, the second domain regulating structure having a third linear component extending in the first direction and a fourth linear component extending in the second direction, the number of at least one of the first and second linear components or the third and fourth linear components being plural, when viewed from a normal direction to the first substrate, the first linear component and the third linear component being alternately arranged, the second linear component and the fourth linear component being alternately arranged, and when a voltage is applied across the liquid crystal layer of an arbitrary pixel, four domains of which tilting directions of liquid crystal molecules are mutually different by about 90° being formed between the first linear component and the third linear component and between the second linear component and the fourth linear component, wherein the arbitrary pixel includes at least one first electrode formed in the first substrate and a second electrode formed in the second substrate, each of the at least one first electrode has a continuous opening pattern, and the first and second linear components of the first domain regulating structure are included in any of the continuous opening patterns included respectively in the at least one first electrode.

Herein, the first electrode is defined by an outer edge of a conductive layer for constituting the electrode, but does not have any relation to the electric potential. For example, when viewed from the side of the liquid crystal layer, if outer edges of two conductive layers (e.g. ITO layers) are mutually independent, the two conductive layers constitute two first electrodes even in the case where substantially the same voltage is supplied to the conductive layers via a drain of one TFT. It is understood that the number of TFTs connected to the conductive layers has no relation to the number of first electrodes.

In the case where an arbitrary pixel has only one first electrode, the first and second linear components of the first domain regulating structure are included in the continuous opening pattern of the only one first electrode. Alternatively, in the case where an arbitrary pixel has a plurality of first electrodes, the first and second linear components of the first domain regulating structure are included in any of the respective continuous opening patterns of the plurality of first electrodes. In other words, the first domain regulating structure is the opening portion formed in the first electrode, and the first and second linear components of the first domain regulating structure do not exist independently in the only one first electrode or in each of the plurality of first electrodes. The first linear components, the second linear components, or the first linear component and the second linear component are coupled, and they are included in the continuous opening pattern of the only one first electrode or each of the plurality of first electrode. Each of the at least one electrode includes only one continuous opening pattern. Typically, each of the at least one first electrode has a plurality of first linear components, a plurality of second linear components, or a pair of a first linear component and a second linear component.

In one embodiment, the at least one first electrode includes a first type of first electrode in which the continuous opening pattern includes a V-shaped opening portion including both of the first and the second linear components. Specifically, herein the first electrode including the V-shaped opening portion is assumed as the first type of first electrode. When the pixel has a rectangular shape having a longer side in the columnar direction, in the first type of first electrode, the V-shaped opening portion may be disposed with the axis parallel to the longer side as an axis of symmetry, or may be disposed with the axis parallel to the shorter side as an axis of symmetry.

In one embodiment, the continuous opening pattern of the first type of first electrode includes a plurality of both of the first and the second linear components, and includes a plurality of V-shaped opening portions.

In one embodiment, the continuous opening pattern of the first type of first electrode further includes a linear opening portion extending in a direction by which an interior angle of the V-shaped opening portion is divided into two equal parts.

In one embodiment, the first type of first electrode has a longer side and a shorter side, and the linear opening portion is parallel to the longer side.

In one embodiment, the linear opening portion is coupled to the center of the plurality of V-shaped opening portions.

In one embodiment, the at least one first electrode further includes a plurality of minute opening portions parallel to a direction substantially orthogonal to the first linear component or the second linear component. The minute opening portion has a width smaller than the width of the first linear component or the second linear component. For example, the first linear component and the second linear component mutually have the same width. When the width is 7 μm to 17 μm, the width of the minute opening portion is 2 μm to 4 μm.

In one embodiment, the plurality of minute opening portions are formed in the vicinity of the center of the V-shaped opening portion. The minute opening portion with such a configuration acts so as to stabilize the orientation of liquid crystal molecules in the vicinity of the center of the V-shaped opening portion.

In one embodiment, the plurality of minute opening portions are formed in the vicinity of an edge of the at least one first electrode. The minute opening portion with such a configuration acts so as to stabilize the orientation of liquid crystal molecules in the vicinity of the edge of the at least one first electrode.

In one embodiment, the plurality of minute opening portions are included in the continuous opening pattern. The minute opening portion is not necessarily included in the continuous opening pattern, but alternatively may be coupled to the continuous opening pattern.

In one embodiment, the at least one first electrode includes a plurality of first electrodes, and the plurality of first electrodes include a second type of first electrode in which the continuous opening pattern includes only either one of the first linear component or the second linear component, and a third type of first electrode in which the continuous opening pattern includes only the other one of the first linear component or the second linear component. Specifically, an arbitrary pixel includes both of the first linear component and the second linear component. However, in the case where the arbitrary pixel includes a plurality of first electrodes, each of the plurality of first electrodes may include either of the first linear components or the second linear components.

In one embodiment, the continuous opening pattern of the second type of first electrode includes a plurality of the first linear components or the second linear components, and the plurality of first linear components or the plurality of second linear components are coupled by a linear coupling opening portion extending in a direction different from the first direction by about 90° or by a linear coupling opening portion extending in a direction different from the second direction by about 90°.

In one embodiment, the plurality of first electrodes includes two first electrodes arranged symmetrically with respect to a gate bus line or a CS bus line, and the continuous opening patterns of the two first electrodes have a line symmetric relationship with the gate bus line or the CS bus line as an axis of symmetry.

In one embodiment, both of the two first electrodes are first type of first electrodes in each of which the continuous opening pattern includes both of the first and the second linear components, and the V-shaped opening portion is disposed in such a manner that the upper side of the V shape is directed to the gate bus line or the CS bus line.

In one embodiment, the continuous opening pattern included in each of the at least one first electrode does not cross the edge of the at least one first electrode.

In one embodiment, when viewed from a normal direction to the first substrate, a respective edge of the at least one first electrode partially overlaps a source bus line. For example, the source bus line has a ladder structure including two parallel main lines and a plurality of branch lines for mutually connecting the two parallel main lines.

In one embodiment, the second domain regulating structure is included in the opening pattern formed in the second electrode or the dielectric projecting pattern formed on the side of the liquid crystal layer of the second electrode.

In one embodiment, in the at least one first electrode, the continuous opening pattern includes a V-shaped opening portion including both of the first and the second linear components, and when viewed from a normal direction to the first substrate, the opening pattern or the dielectric projecting pattern of the second electrode further includes a linear opening portion or a linear dielectric protrusion extending in a direction for dividing an interior angle of the V-shaped opening portion into two equal parts.

In one embodiment, when viewed from the normal direction to the first substrate, the at least one first electrode is in parallel with the linear opening portion or the linear dielectric protrusion of the second electrode extending in the direction for dividing the interior angle of the V-shaped opening portion into two equal parts, and does not have an opening portion which overlaps the linear opening portion or the linear dielectric protrusion of the second electrode.

### Advantageous Effects of Invention

In the MVA liquid crystal display device of the present invention, each of the first electrodes has a continuous opening portion, so that it is possible to obtain a larger number of separated portions than the prior art in a smaller number of cutting positions than the prior art. Accordingly, the short circuit due to a conductive foreign material existing on the first electrode can easily be restored.

### BRIEF DESCRIPTION OF DRAWINGS

FIGS. 1 (a) and (b) are cross-sectional views schematically showing an exemplary fundamental configuration of an LCD in one embodiment of the present invention.

FIGS. 2 (a) and (b) are schematic plan views showing an exemplary arrangement of liquid crystal domains in one pixel of the LCD in one embodiment of the present invention, in which (a) schematically shows an arrangement of liquid crystal domains in a normal pixel, and (b) schematically shows an arrangement of liquid crystal domains in a pixel having multi-pixel configuration.

FIGS. 3 (a) and (b) are plan views schematically showing an electric configuration of a pixel, in which (a) shows an electric configuration of a normal pixel, and (b) shows an electric configuration of a pixel having multi-pixel configuration.

FIG. 4 is a diagram showing an equivalent circuit of the liquid crystal display device in one embodiment of the present invention.

FIG. 5 is a diagram showing exemplary voltage waveforms and timings of respective signals for driving the liquid crystal display device shown in FIG. 4.

FIG. 6 (a) to (C) are views for illustrating the pixel configuration of an LCD 100 in one embodiment of the present invention, in which (a) is a plan view showing the configuration of one pixel of the LCD 100, (b) is a plan view showing a continuous opening pattern 20 formed in a first substrate 100A, and (c) is a plan view showing a dielectric projecting pattern 44 formed on a second substrate 100B.

FIGS. 7 (a) and (b) are diagrams for illustrating a method for restoring a short-circuit failure, in which (a) is a schematic diagram in the case with a source bus line having a ladder structure, and (b) is a schematic diagram in the case with a redundancy wiring 19.

FIG. 8 is a plan view showing a continuous opening pattern 20 formed in a first substrate 110A which is used instead of the first substrate 100A of the LCD 100 shown in FIG. 6.

FIG. 9 (a) to (c) are views for illustrating the pixel configuration of an LCD 120 in another embodiment of the present invention, in which (a) is a plan view showing the configuration of one pixel of the LCD 120, (b) is a plan view showing a continuous opening pattern 20 formed in a first substrate 120A, and (c) is a plan view showing a dielectric projecting pattern 44 formed on a second substrate 120B.

FIG. 10 (a) to (c) are views for illustrating the pixel configuration of an LCD 130 in still another embodiment of the present invention, in which (a) is a plan view showing the configuration of one pixel of the LCD 130, (b) is a plan view showing a continuous opening pattern 20 formed in a first substrate 130A, and (c) is a plan view showing a dielectric projecting pattern 44 formed on a second substrate 130B.

FIG. 11 (a) to (c) are views for illustrating the pixel configuration of an LCD 200 in still another embodiment of the present invention, in which (a) is a plan view showing the configuration of one pixel of the LCD 200, (b) is a plan view showing a continuous opening pattern 20 formed in a first substrate 200A, and (c) is a plan view showing a dielectric projecting patter 44 formed on a second substrate 200B.

FIG. 12 (a) to (c) are views for illustrating the pixel configuration of an LCD 210 in still another embodiment of the present invention, in which (a) is a plan view showing the configuration of one pixel of the LCD 210, (b) is a plan view showing a continuous opening pattern 20 formed in a first substrate 210A, and (c) is a plan view showing a dielectric projecting pattern 44 formed on the second substrate 210B.

FIG. 13 (a) to (c) are views for illustrating the pixel configuration of an LCD 220 in still another embodiment of the present invention, in which (a) is a plan view showing the configuration of two pixels of the LCD 220, (b) is a plan view showing a continuous opening pattern 20 formed in a first substrate 220A, and (c) is a plan view showing a dielectric projecting pattern 44 formed on a second substrate 220B.

FIG. 14 is a plan view showing a continuous opening pattern 20 formed in a first substrate 230A used instead of the first substrate 220A of the LCD 220 shown in FIG. 13.

FIG. 15 is a plan view showing a dielectric projecting pattern 44 in an LCD 240 in which the second substrate 220B of the LCD 220 shown in FIG. 13 is changed.

FIG. 16 (a) to (d) are plan views for illustrating variations of a linear coupling portion.

FIG. 17 (a) to (c) are views for illustrating the pixel configuration of an LCD 250 in still another embodiment of the present invention, in which (a) is a plan view showing the configuration of two pixels in the LCD 250, (b) is a plan view showing a continuous opening pattern 20 formed in a first substrate 250A, and (c) is a plan view showing a dielectric projecting pattern 44 formed on a second substrate 250B.

FIG. 18 is a plan view showing first electrodes 21a and 21b in an LCD 260 in which the first substrate 250A of the LCD 250 shown in FIG. 17 is changed.

FIG. 19 (a) to (c) are views for illustrating the pixel configuration of an LCD 300 in still another embodiment of the present invention, in which (a) is a plan view showing the configuration of two pixels of the LCD 300, (b) is a plan view showing a continuous opening pattern 20 formed in a first substrate 300A, and (c) is a plan view showing a dielectric projecting pattern 44 formed on a second substrate 300B.

FIGS. 20 (a) and (b) are views for illustrating the pixel configuration of an LCD 310 in still another embodiment of the present invention, in which (a) is a plan view showing the configuration of two pixels of the LCD 310 and a plan view showing a continuous opening pattern 20 and an opening pattern 42, and (b) is a plan view showing a dielectric projecting pattern 44 formed on a second substrate 310B.

FIG. 21 is a view showing the pixel configuration of an LCD 320 in still another embodiment of the present invention, and a plan view showing a dielectric projecting pattern 44.

FIGS. 22 (a) and (b) are views for illustrating the pixel configuration of an LCD 330 in still another embodiment of the present invention, in which (a) is a plan view showing a continuous opening pattern 20 and a dielectric projecting pattern 44, and (b) is a plan view showing the continuous opening pattern 20.

FIG. 23 is a view for illustrating the pixel configuration of an LCD 340 in still another embodiment of the present invention.

FIG. 24 is a view for illustrating the pixel configuration of an LCD 350 in still another embodiment of the present invention.

FIGS. 25 (a) and (b) are views for illustrating the pixel configuration of an LCD 360 in still another embodiment of the present invention, in which (a) is a plan view showing a continuous opening pattern 20 and a dielectric projecting pattern 44, and (b) is a plan view showing the continuous opening pattern 20.

FIGS. 26 (a) and (b) are views for illustrating the pixel configuration of an LCD 370 in still another embodiment of the present invention, in which (a) is a plan view showing a continuous opening pattern 20 and a dielectric projecting pattern 44, and (b) is a plan view showing the continuous opening pattern 20.

FIGS. 27 (a) and (b) are views for illustrating the pixel configuration of an LCD 380 in still another embodiment of the present invention, in which (a) is a plan view showing a continuous opening pattern 20 and a dielectric projecting pattern 44, and (b) is a plan view showing the continuous opening pattern 20 included in a first substrate 380A.

FIGS. 28 (a) and (b) are views for illustrating the pixel configuration of an LCD 390 in still another embodiment of the present invention, in which (a) is a plan view showing a continuous opening pattern 20 and a dielectric projecting pattern 44, and (b) is a plan view showing the continuous opening pattern 20 included in a first substrate 390A.

### DESCRIPTION OF EMBODIMENTS

Hereinafter the configuration of an MVA liquid crystal display device (hereinafter abbreviated as an LCD) in one embodiment of the present invention will be described with reference to the drawings.

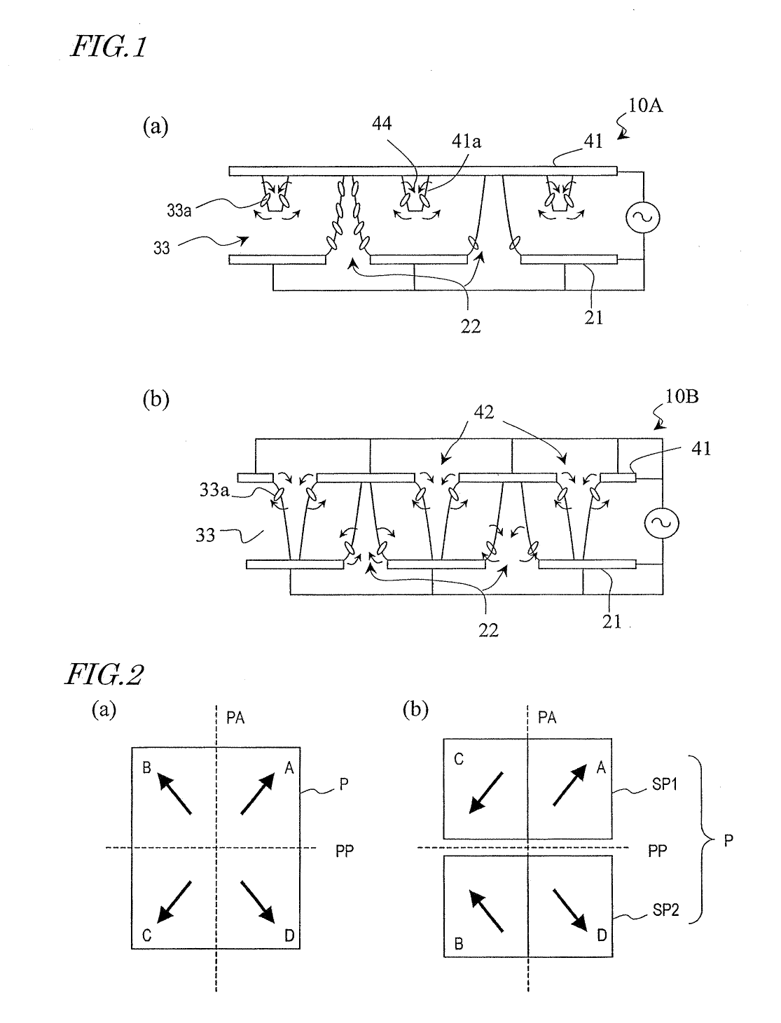

First, with reference to FIG. 1(a) and FIG. 1(b), the fundamental configuration of the MVA LCD in one embodiment of the present invention will be described.

The LCD 10A and LCD 10B are provided with a plurality of pixels, each including a first electrode 21 formed on a first substrate, a second electrode 41 formed on a second substrate, the second electrode 41 being opposite to the first electrode 21, and a vertical alignment liquid crystal layer 33 disposed between the first electrode 21 and the second electrode 41. In the vertical alignment liquid crystal layer 33, liquid crystal molecules 33a with negative dielectric anisotropy in no voltage application are aligned substantially vertically (e.g., 87° and more and 90° and less) to surfaces of the first electrode 21 and the second electrode 41. Typically, the alignment can be attained by providing a vertical alignment film (not shown) on the respective surfaces of the first electrode 21 and the second electrode 41 on the side of the liquid crystal layer 33. In the case where a dielectric protrusion (rib) or the like is provided as a domain regulating structure, the liquid crystal molecules 33a are aligned substantially vertically with respect to the surface of the dielectric protrusion or the like on the side of the liquid crystal layer.

On the side of the first electrode 21 of the liquid crystal layer 33, a first domain regulating structure 22 is provided, and on the side of the second electrode 41 of the liquid crystal layer 33, a second domain regulating structure (an opening portion 42 or a dielectric protrusion 44) is provided. In a liquid crystal region defined between the first domain regulating structure and the second domain regulating structure, the liquid crystal molecules 33a are influenced by the alignment regulating power from the first domain regulating structure and the second domain regulating structure. When a voltage is applied between the first electrode 21 and the second electrode 41, the liquid crystal molecules 33a are tilted (inclined) in a direction indicated by an arrow in the figure. That is, the liquid crystal molecules 33a are tilted in the uniform direction in the respective liquid crystal regions, so that each of the liquid crystal regions can be regarded as a domain.

The first domain regulating structure and the second domain regulating structure (they may sometimes be referred to collectively as “domain regulating structures”) are respectively disposed linearly (in a strip-shaped manner) in the respective pixel. FIG. 1(a) and FIG. 1(b) are cross-sectional views of the linear domain regulating structures in a direction orthogonal to the extending direction thereof. On both sides of each of the domain regulating structures, liquid crystal domains in which the tilting directions of liquid crystal molecules 33a are mutually different by 180° are formed.

The LCD 10A shown in FIG. 1(a) has an opening portion (a slit) 22 as the first domain regulating structure formed in the first electrode 21, and a dielectric protrusion 44 as the second domain regulating structure formed on the second electrode 41 on the side of the liquid crystal layer 33. The opening portion 22 and the dielectric protrusion 44 are extended linearly (in a strip-like manner). In the dielectric protrusion 44, the liquid crystal molecules 33a are directed in a direction substantially perpendicular to the side face 41a thereof, so as to direct the liquid crystal molecules 33a in a direction orthogonal to the extending direction of the dielectric protrusion 44. As for the opening portion 22, when a potential difference is formed between the first electrode 21 and the second electrode 41, an oblique electric field is generated in the liquid crystal layer 33 in the vicinity of the edge of the opening portion 22, so as to direct the liquid crystal molecules 33a in a direction orthogonal to the extending direction of the opening portion 22. The opening portions 22 and the dielectric protrusions 44 are located in parallel with each other at regular intervals. A liquid crystal domain is formed between an opening portion 22 and a dielectric protrusion 44 which are adjacent to each other.

An LCD 10B shown in FIG. 1(b) is different from the LCD 10A shown in FIG. 1(a) in that the LCD 10B includes an opening portion 22 and an opening portion 42 as a first domain regulating structure and a second domain regulating structure, respectively. As for the opening portion 22 and the opening portion 42, when a potential difference is formed between the first electrode 21 and the second electrode 41, an oblique electric field is generated in the liquid crystal layer 33 in the vicinity of edges of the opening portions 22 and 42, so as to direct the liquid crystal molecules 33a in a direction orthogonal to the extending direction of the opening portions 22 and 42. The opening portion 22 and the opening portion 42 are located in parallel with each other at regular intervals, and a liquid crystal domain is formed between them.

In the MVA LCD in one embodiment of the present invention, the first electrode 21 is a pixel electrode (or a sub-pixel electrode), and the second electrode 41 is a counter electrode. The first domain regulating structure is the opening portion 22 formed in the first electrode 21, and the second domain regulating structure is the dielectric protrusion 44 formed on the side of the liquid crystal layer of the counter electrode 41 or the opening portion 42 formed in the counter electrode 42.

In addition, as described later by way of a specific example, the first domain regulating structure includes a first linear component extending in a first direction, and a second linear component extending in a second direction which is different from the first direction by about 90°. The second domain regulating structure includes a third linear component extending in the first direction (parallel to the first linear component), and a fourth linear component extending in the second direction (parallel to the second linear component). As for at least one of the first and second linear components and the third and second linear components, there exist plural components. When viewed from a normal direction to the first substrate, the first linear component and the third linear component are alternately disposed, and the second linear component and the fourth linear component are alternately disposed.

Accordingly, when a voltage is applied across the liquid crystal layer of an arbitrary pixel, between the first linear component and the third linear component and between the second linear component and the fourth linear component, four domains in which the tilt directions of the liquid crystal molecules are mutually different by about 90° are formed.

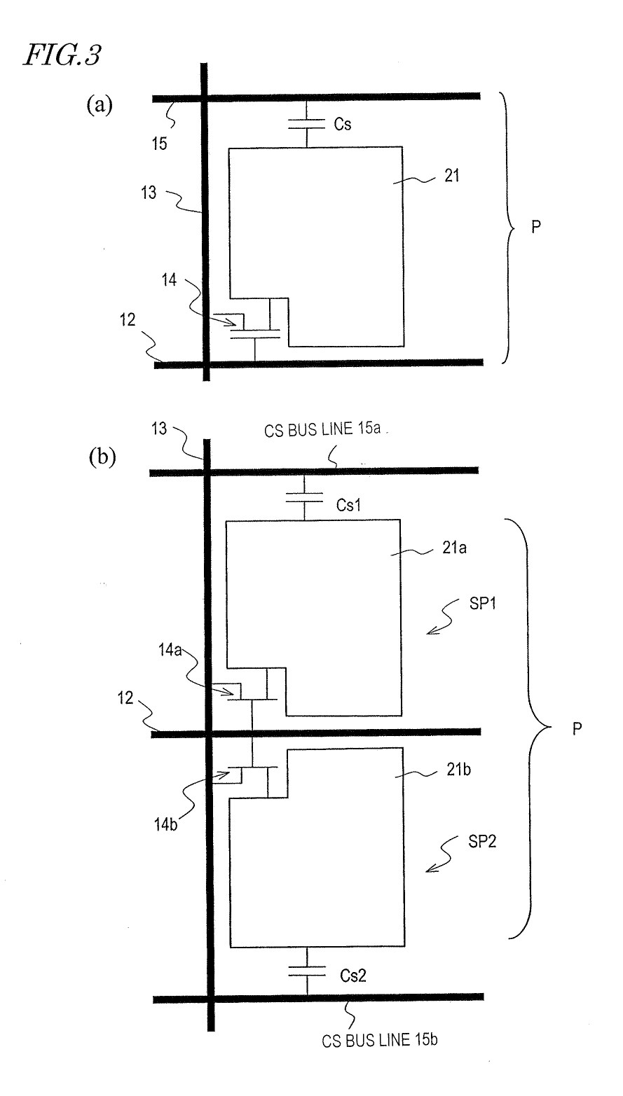

FIG. 2(a) and FIG. 2(b) are schematic plan views showing an exemplary arrangement of liquid crystal domains in one pixel of an MVA LCD in one embodiment of the present invention. FIG. 2(a) schematically shows the arrangement of liquid crystal domains in a normal pixel, and FIG. 2(b) schematically shows the arrangement of liquid crystal domains in a pixel having multi-pixel structure. The letters PP in FIG. 2(a) and FIG. 2(b) indicate a polarization axis of a polarization plate on a back-face side (on the side of a back light), and the letters PA indicate a polarization axis of a polarization plate on the side of an observer.

As shown in FIG. 2(a), in the case of the normal pixel, four domains A, B, C, and D are formed in one pixel P. In the domains A, B, C, and D, directions in which liquid crystal molecules are tilted when a voltage is applied across the liquid crystal layer (referred to as “alignment directions of directors of liquid crystal domains”) are mutually different by about 90°. In the case of the multi-pixel structure, as shown in FIG. 2(b), four liquid crystal domains A, B, C, and D are formed in one pixel P. In respective sub-pixels SP1 and SP2, only a pair of liquid crystal domains having alignment directions of directors which are mutually different by 180° may be formed. It is understood that the first and second domain regulating structures may be disposed so as to form four liquid crystal domains A to D in each sub-pixel. In addition, each pixel P may have two or more respective liquid crystal domains A to D.

Next, with reference to FIG. 3 to FIG. 5, the multi-pixel structure of the MVA LCD in one embodiment of the present invention will be described.

FIG. 3(a) and FIG. 3(b) are plan views schematically showing the pixel configuration. FIG. 3(a) shows the pixel configuration of a normal pixel, and FIG. 3(b) shows the pixel configuration having a multi-pixel structure. In both figures, the second electrode (a counter electrode) 41 is omitted.

As shown in FIG. 3(a), the normal pixel P is defined by a first electrode (a pixel electrode) 21. The first electrode 21 is electrically connected to a source bus line 13 via a TFT 14 which is connected to a gate bus line 12. A CS capacitance is formed in parallel with a liquid crystal capacitance constituted by the first electrode 21, and the liquid crystal layer and the second electrode. One end of the CS capacitance is connected to the first electrode 21, and the other is connected to a CS bus line 15.

On the other hand, the pixel P having the multi-pixel structure is divided into a sub-pixel SP1 and a sub-pixel SP2, as shown in FIG. 3(b). To first pixel electrodes (sub-pixel electrodes) 21a and 21b constituting the sub-pixels SP1 and SP2, corresponding TFT 14a, TFT 14b, and storage capacitors CS1 and CS2 are connected, respectively. Gate electrodes of the TFT 14a and TFT 14b are connected to a common gate bus line (a scanning line) 12, and source electrodes of the TFT 14a and TFT 14b are connected to a common (the same) source bus line (a signal line) 13. The storage capacitors CS1 and CS2 are connected to corresponding CS bus lines (storage capacitor lines) 15a and 15b, respectively. The storage capacitors CS1 and CS2 are constituted by storage capacitor electrodes electrically connected to the first electrodes 21a and 21b, respectively, storage capacitor counter electrodes electrically connected to the CS bus lines 15a and 15b, and an insulating layer (not shown, e.g., a gate insulating layer) formed therebetween. The storage capacitor counter electrodes of the storage capacitors CS1 and CS2 are mutually independent, and have the structures in which storage capacitor counter voltages (also referred to as “CS signals”) which is mutually different can be supplied from the CS bus lines 15a and 15b, respectively.

A display signal voltage is supplied from the common source bus line 13 to the first electrode 21a and the first electrode 21b, so as to turn off the TFT 14a and the TFT 14b. Thereafter, variations (defined by the direction and the magnitude of variation) of voltages of the storage capacitor counter electrodes of the storage capacitors CS1 and CS2 (i.e., voltages supplied from the CS bus line 15a or the CS bus line 15b) are differentiated, so as to attain a condition where effective voltages to be applied across the liquid crystal capacitances of the respective sub-pixels SP1 and SP2 are different, i.e., a condition with different degrees of luminance. With such a configuration, display signal voltages can be supplied to the two sub-pixels SP1 and SP2 from one source bus line 13, so that the luminance of the sub-pixels SP1 and SP2 can be mutually differentiated without increasing the number of source bus lines and the number of source drivers.

For example, with respect to a supplied display signal voltage, the display luminance of the sub-pixel SP1 is higher than the sub-pixel SP2. Herein the sub-pixel SP1 does not necessarily perform the display with higher luminance than the sub-pixel SP2 with respect to all of the display signal voltages (gray-scale display signals), but may perform the display with higher luminance with respect to at least one halftone display signal voltage. Typically, in all of the halftone gray scales excluding black (the lowest gray scale) and white (the highest gray scale), for example, the sub-pixel SP1 performs the display with higher luminance than the sub-pixel SP2. Alternatively, the order of luminance may be changed for each frame, for example.

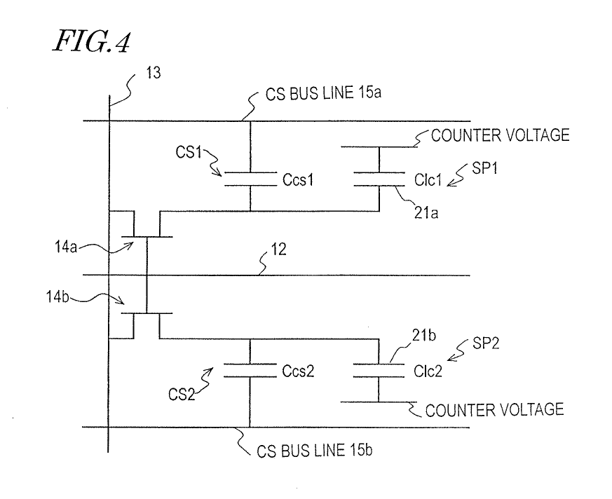

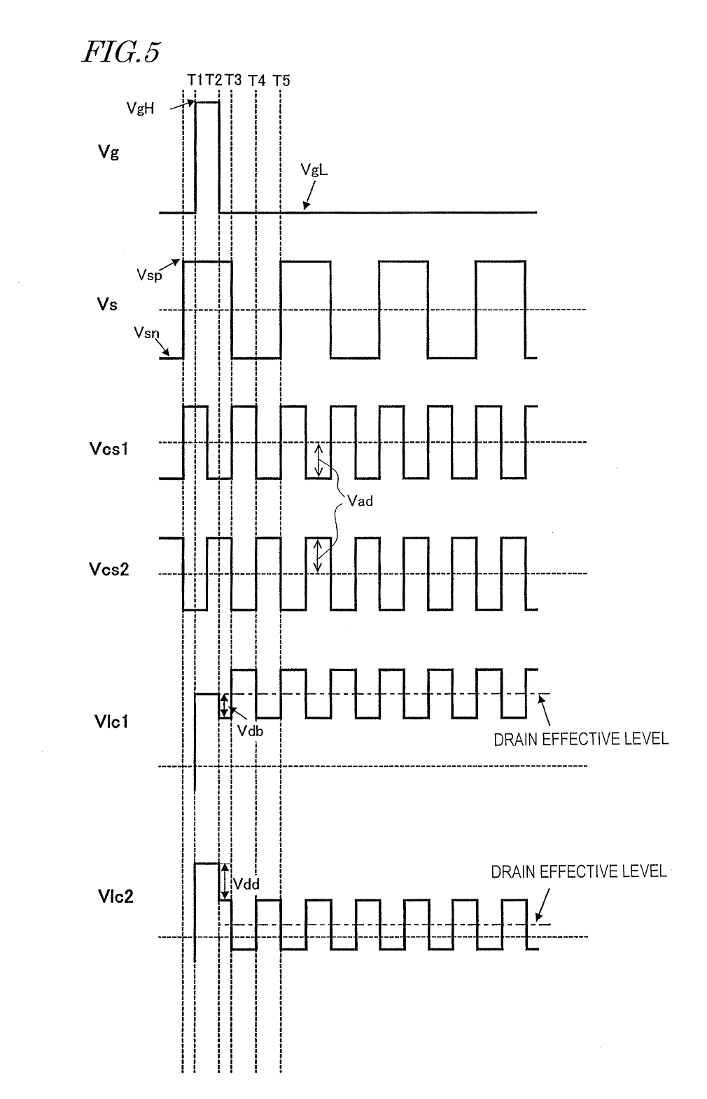

Next, with reference to FIG. 4 and FIG. 5, the multi-pixel driving method will be briefly described. FIG. 4 is a diagram showing an equivalent circuit of an LCD having the multi-pixel structure. FIG. 5 is a chart showing exemplary voltage waveforms and timings of respective signals for driving the LCD shown in FIG. 4.

By applying voltages of respective bus lines shown in FIG. 5, the sub-pixel SP1 is a light sub-pixel, and the sub-pixel SP2 is a dark sub-pixel. The reference letter Vg denotes a gate voltage, Vs denotes a source voltage, Vcs1 and Vcs2 denote voltages of respective storage capacitors of the sub-pixel SP1 and the sub pixel SP2, and Vlc1 and Vlc2 denote voltages of pixel electrodes of the sub-pixel SP1 and the sub-pixel SP2, respectively.

In the present embodiment, as shown in FIG. 5, for a medium value Vsc of the source voltage, Vsp is applied to the source voltage as a plus polarity. To CS1 and CS2, a signal in which the voltage thereof is caused to oscillate at an amplitude voltage Vad, and the phases of CS1 and CS2 are shifted by 180 degrees is input.

At time T1, Vg is varied from VgL to VgH, and the TFTs of both sub-pixels are turned ON, so that the voltage of Vsp is charged to the sub-pixel SP1, the sub-pixel SP2, and the storage capacitors CS1 and CS2.

At time T2, Vg is varied from VgH to VgL, and the TFTs of both sub-pixels are turned OFF, so that the sub-pixel SP1, the sub-pixel SP2, and the storage capacitors CS1 and CS2 are electrically insulated from the source bus line. Immediately after this, due to the pull-in effect influenced by the parasitic capacitance and the like, pull-in voltages of Vdb and Vdd are caused in the sub-pixels SP1 and SP2, respectively, and the voltage of the respective sub-pixels are represented as follows:

Vlc1=Vsp−Vdb

Vlc2=Vsp−Vdd.

At this time, the voltages Vcs1 and Vcs2 are represented as follows:

Vcs1=Vcom−Vad

Vcs2=Vcom+Vad

At time T3, the voltage Vcs1 of the storage capacitor bus line CS1 is varied from Vcom−Vad to Vcom+Vad, and the voltage Vcs2 of the storage capacitor bus line CS2 is varied from Vcom+Vad to Vcom−Vad. At this time, the pixel voltages Vlc1 and Vlc2 of the respective sub-pixels are represented as follows:

Vlc1=Vsp−Vdb+2·K·Vad

Vlc2=Vsp−Vdd−2·K·Vad,

where K=Ccs/(Clc(V)+Ccs). In the equations, the symbol “·” indicates the multiplication.

At time T4, the voltage Vcs1 is varied from Vcom+Vad to Vcom−Vad, and the voltage Vcs2 is varied from Vcom−Vad to Vcom+Vad. At this time, the sub-pixel voltages Vlc1 and Vlc2 are represented as follows:

Vlc1=Vsp−Vdb

Vlc2=Vsp−Vdd.

At time T5, the voltage Vcs1 is varied from Vcom−Vad to Vcom+Vad, and Vcs2 is varied from Vcom+Vad to Vcom−Vad. At this time, the sub-pixel voltages Vlc1 and Vlc2 are represented as follows:

Vlc1=Vsp−Vdb+2·K·Vad

Vlc2=Vsp−Vdd−2·K·Vad.

Thereafter, until the writing is performed in the condition of Vg=VgH, for every integral multiple of horizontal writing period 1H, the voltages Vcs1 and Vcs2 and the voltages Vlc1 and Vlc2 alternately repeat the conditions of the time T4 and the time T5. Accordingly, the effective values of Vlc1 and Vlc2 are represented as follows:

Vlc1=Vsp−Vdb+K·Vad

Vlc2=Vsp−Vdd−K·Vad.

In the n-th frame, the effective voltage applied across the liquid crystal layers of the respective sub-pixels are represented as follows:

V1=Vsp−Vdb+K·Vad−Vcom

V2=Vsp−Vdd−K·Vad−Vcom,

so that the sub-pixel SP1 is a light sub-pixel, and the sub-pixel SP2 is a dark sub-pixel.

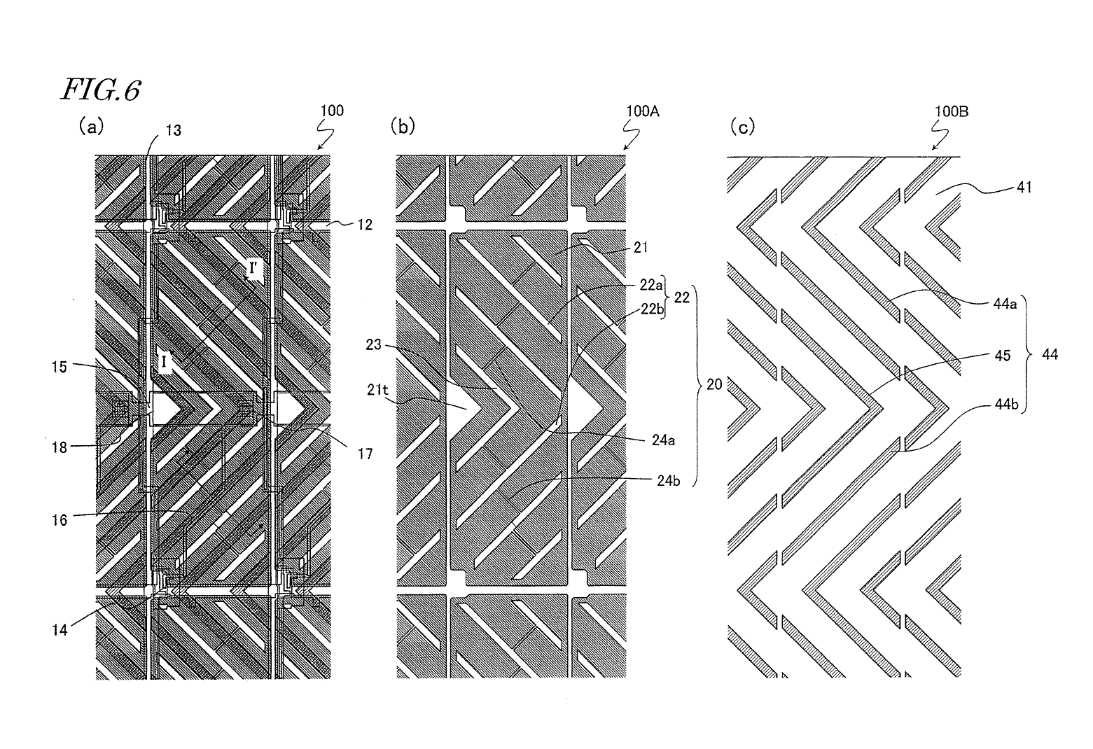

Next, with reference to FIG. 6, the pixel configuration of an LCD 100 in the embodiment of the present invention will be described. FIG. 6(a) is a plan view showing the configuration of one pixel of the LCD 100. FIG. 6(b) is a plan view showing a continuous opening pattern 20 formed in a first substrate (a TFT substrate) 100A. FIG. 6(c) is a plan view showing a dielectric projecting pattern 44 formed on a second substrate (a counter substrate) 100B. The aspect ratios in FIG. 6 and FIG. 8 to FIG. 28 reflect the actual aspect ratio of the pixel of the LCD.

The LCD 100 includes a normal pixel (without having a multi-pixel structure). As shown in FIG. 6(a), the LCD 100 includes a gate bus line 12, a source bus line 13, a TFT 14, a CS bus line 15, a drain lead-out wiring 16, a contact hall 17, and a CS counter electrode 18. The electric configuration of the LCD 100 is the same as shown in FIG. 3(a).

As shown in FIG. 6(b), a first electrode 21 has an opening portion 22 as a first domain regulating structure. The opening portion 22 has four first linear components 22a (downward to the right by 45°) and four second linear components 22b (downward to the left by 45°). Among them, one first linear component 22a and one second linear component 22b are directly coupled, thereby forming a V-shaped opening portion 23. The four first linear components 22a are mutually coupled via linear coupling opening portions 24a which extend in a direction different from the first linear component 22a by about 90°, and the four second linear components 22b are mutually coupled via linear coupling opening portions 24b which extend in a direction different from the second linear component 22b by about 90°. Since the linear coupling opening portions 24a and 24b generate an electric field which disturbs the alignment of liquid crystal molecules in a liquid crystal domain, it is preferred that the widths thereof are smaller than the widths of the first linear component 22a and the second linear component 22b. As described above, all of the opening portions formed in the first electrode 21 are coupled, so as to form one continuous opening pattern 20. The opening pattern 20 has a line symmetric characteristic with respect to a line parallel to the gate bus line 12 (or the CS bus line 15) as an axis of symmetry.

At the left edge in the vicinity of the center in the column direction of the first electrode 21, a notch 21t having a side which is parallel to the V-shaped opening portion 23 is formed, so as to stabilize the orientation of liquid crystal molecules in the vicinity of the notch 21t.

As shown in FIG. 6(c), the second substrate 100B has a dielectric projecting pattern 44 as a second domain regulating structure on the side of the liquid crystal layer of the second electrode 41. The dielectric projecting pattern 44 has five third linear components 44a (downward to the right by 45°) which are parallel to the first linear components 22a, and five fourth linear components 44b (downward to the left by 45°) which are parallel to the second linear components 22b. Among them, two third linear components 44a and two fourth linear components 44b are directly coupled, so as to form two V-shaped dielectric protrusions 45. As shown in FIG. 6(a), the five third linear components 44a and the five fourth linear components 44b are arranged in parallel with the four first linear components 22a and the four second linear components 22b in an alternating manner. Between them, four kinds of liquid crystal domains (see FIG. 2(a)) are formed.

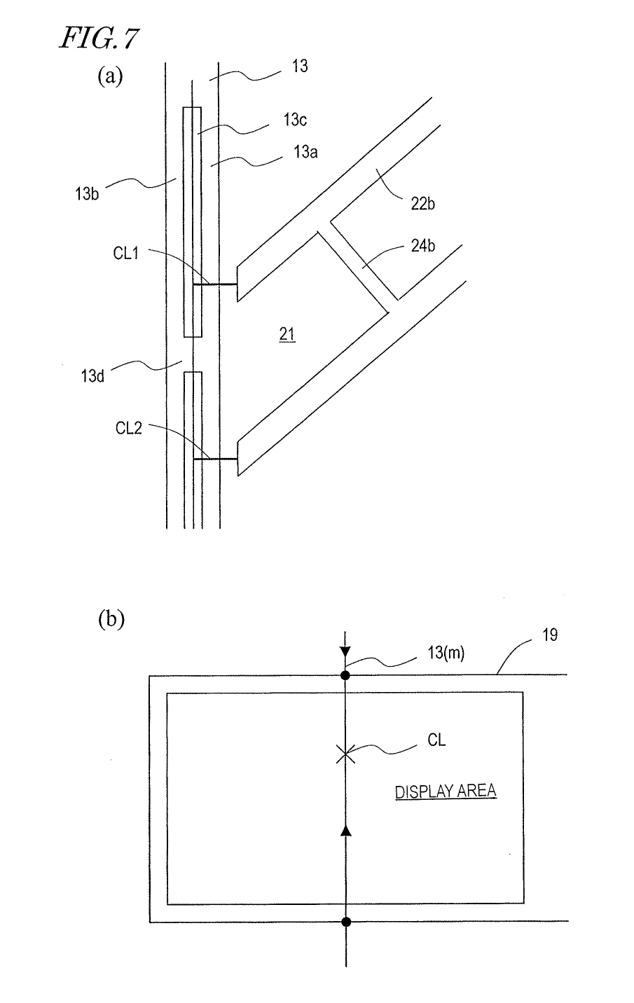

With reference to FIG. 6(b) and FIG. 7, advantages obtained by the condition where an opening portion functioning as the first domain regulating structure formed in the first electrode 21 (the first linear component and the second linear component) is part of the continuous opening pattern will be described.

As shown in FIG. 6(b), since the opening pattern 20 is continuous, if end portions of two adjacent first linear components 22a, end portions of two adjacent second linear components 22b which exist in the vicinity of the edge of the first electrode 21, or a portion from the end portion of the first linear component 22a and the end portion of the second linear component 23a to the edge of the first electrode 21 are cut off, a small region can be separated from the first electrode 21.

For example, as shown in FIG. 7(a), when the cut-off is performed from the end portions of the two adjacent second linear components 22b to the edge of the first electrode 21 along cutting lines CL1 and CL2, a portion surrounded by the two second linear components 22b, the linear coupling opening portion 24b, the cutting line CL1 and CL2, and the edge of the first electrode 21 is separated from the first electrode 21, i.e., becomes electrically independent from the first electrode 21. Accordingly, in the case where any conductive foreign material exists in this region, and short circuit occurs between the first electrode 21 and the second electrode 41, the short circuit can be restored by performing the cut-off along the cutting lines CL1 and CL2. In FIG. 7(a), for the simplicity, the representation of a first electrode 21 in a pixel which is adjacent in the row direction is omitted.

As shown in FIG. 6(b), by utilizing the end portions of the continuous opening pattern 20, small portions can be separated in 14 ways from the first electrode 21 by performing the cut-off only at two places. As described above, by adopting the configuration in which the continuous opening pattern 20 does not intersect with the edge of the first electrode 21, the number of cut-off places to be selected can be increased, so that the short-circuit defect can be effectively restored.

Accordingly, as compared with the conventional configuration without the linear coupling opening portions 24a and 24b, the LCD 100 attains the advantage that the restoration can be performed with smaller number of cut-off points. In addition, a portion which is smaller as compared with the conventional one can be selected and electrically separated, so that it is possible to attain another advantage that the area which can be utilized after the restoration can be larger than that in the conventional case. It should be noted that if a portion including the contact hole 17 for electrically connecting the first electrode 21 to the drain of the TFT 14 is separated, the function as the first electrode 21 is lost.

Herein as exemplarily shown, in the case where only one contact hole 17 is provided, the short-circuit defect cannot be restored with the probability of 1/14. If a redundancy structure in which a plurality of contact holes 17 are formed is adopted, the number of cases where the short-circuit defect cannot be restored can be further reduced. However, in the configuration where a plurality of contact holes 17 are provided, if a portion including a certain one contact hole is separated from the first electrode 21, the separated portion is electrically connected to the drain of the TFT via the contact hole, so that it is necessary to cut off the wiring from the contact hole included in the separated portion to the drain of the TFT. Accordingly, in the case where a plurality of contact holes are provided, the wirings for electrically connecting the respective contact holes to the drains of corresponding TFTs are provided with a branch-connection structure in which the wirings can be mutually independently cut off. Such a structure is disclosed in Japanese Laid-Open Patent Publication No. 2002-55361 (e.g., FIG. 4). For the purpose of reference, the entire disclosure of Japanese Laid-Open Patent Publication No. 2002-55361 is hereby incorporated by reference.

In order to improve effective open area ratio, when the configuration in which part of the edge of the first electrode 21 overlaps the source bus line 13 is adopted, it is preferred that the source bus line 13 may adopt a ladder structure as shown in FIG. 7(a). The source bus line 13 shown in FIG. 7(a) includes two parallel main lines 13a and 13b, and a plurality of branch lines 13d for mutually connecting the two parallel main lines 13a and 13b. An opening portion 13c is formed in the source bus line 13. Such a ladder structure is disclosed in International Publication No. 07/34596. For the purpose of reference, the entire disclosure of International Publication No. 07/34596 is hereby incorporated by reference.

In the case where such a ladder structure is adopted, when the first electrode 21 is cut off along the cutting lines CL1 and CL2, even if the main line 13a existing under them is cut off, the conductive condition can be ensured by the main line 13b, so that there is no restriction for cutting positions.

Even in the case where the ladder structure is not used for the source bus line, as shown in FIG. 7(b), it is sufficient that a redundancy wiring 19 may be provided. For example, in the case where the source bus line 13(m) is cut off at point CL for restoration, the redundancy wiring 19 is connected at two places indicated by the symbol , the display signal voltage can be supplied in a reverse direction of the source bus line 13(m). The configuration provided with such a redundancy wiring is disclosed in Japanese Laid-Open Patent Publication No. 2008-197583. For the purpose of reference, the entire disclosure of Japanese Laid-Open Patent Publication No. 2008-197583 is hereby incorporated by reference.

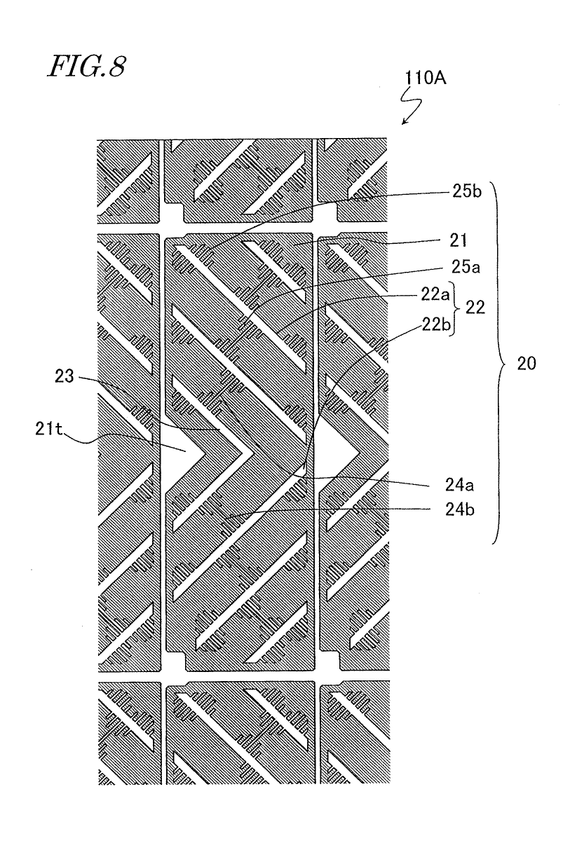

Hereinafter, with reference to FIG. 8 through FIG. 28, examples of opening pattern in an LCD in other embodiments of the present invention will be described. The common components are indicated by the common reference numerals, and the descriptions thereof may be omitted.

FIG. 8 is a plan view showing a continuous opening pattern 20 formed in a first substrate 110A used instead of the first substrate 100A in the LCD 100 shown in FIG. 6.

The continuous opening pattern 20 of a first electrode 21 included in the first substrate 110A has, in addition to the continuous opening pattern 20 of the first substrate 21 in the first substrate 100A, a plurality minute opening portions 25a and 25b which are parallel to a direction substantially orthogonal to the first linear components 22a or the second linear components 22b. The minute opening portions 25a and 25b have widths smaller than the width of the first linear component 22a or the second linear component 22b. For example, when the first linear component 22a and the second linear component 22b have the same width which is 7 μm to 17 μm, the minute opening portions 25a and 25b have the widths of 2 μm to 4 μm, respectively, and they are arranged mutually parallel at intervals of 2 μm to 4 μm.

The minute opening portion 25a is formed in the vicinity of the linear coupling opening portions 24a and 24b, thereby acting so as to stabilize the orientation of liquid crystal molecules in the vicinity of the linear coupling opening portions 24a and 24b. The liquid crystal molecules between the mutually adjacent two minute opening portions 25a are equally affected by the oblique electric field from the two minute opening portions 25a, and also affected by the oblique electric field from the first linear component 22a or the second linear component 22b, so as to be aligned in parallel with a direction in which the minute opening portion 25a extends. In order to stably orient the liquid crystal molecules in a direction orthogonal to the first linear component 22a or the second linear component 22b, it is preferred that the minute opening portion 25a may be disposed in the direction orthogonal to the first linear component 22a or the second linear component 22b. However, in the range in which the above-mentioned effects can be attained, the direction may be deviated from the orthogonal relationship.

The minute opening portions 25b are formed in the vicinity of the edge of the first electrode 21, thereby acting so as to stabilize the orientation of liquid crystal molecules in the vicinity of the edge of the first electrode 21, similarly to the minute opening portions 25a. The minute opening portions 25b are disposed only on the side on which the first linear component 22a or the second linear component 22b and the edge of the first electrode 21 form an acute angle. Alternatively, the minute opening portions 25b may be disposed on the side on which the first linear component 22a or the second linear component 22b and the edge of the first electrode 21 form an obtuse angle, or may be disposed on both sides.

Herein the minute opening portions 25a and 25b are included in the continuous opening pattern 20. It is not necessarily that the minute opening portions 25a and 25b are included in the continuous opening pattern 20, but it is preferred that they may be coupled to the continuous opening pattern 20, because the orientation of liquid crystal molecules may easily be stabilized by the influence of the oblique electric field from the first linear component 22a or the second linear component 22b.

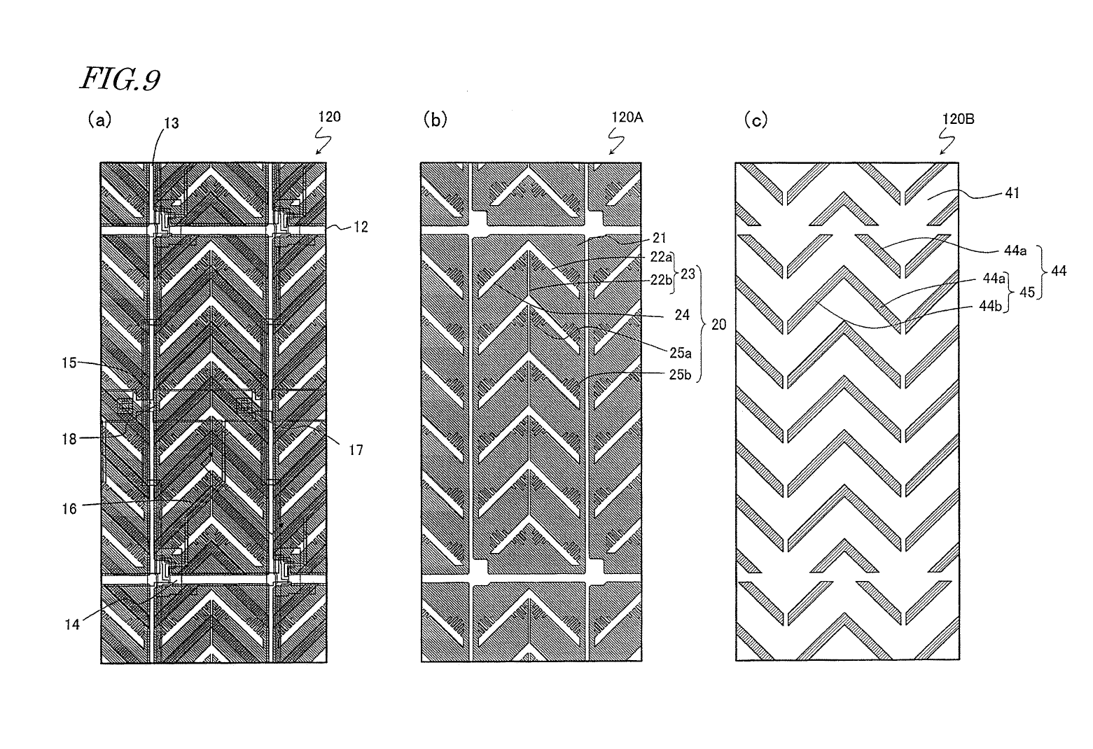

Next, with reference to FIG. 9, the pixel configuration of an LCD 120 in another embodiment of the present invention will be described. FIG. 9(a) is a plan view showing the configuration of one pixel in the LCD 120. FIG. 9(b) is a plan view showing a continuous opening pattern 20 formed in a first substrate 120A. FIG. 9(c) is a plan view showing a dielectric projecting pattern 44 formed on a second substrate 120B. The pixel of the LCD 120 is also a normal pixel similarly to the LCD 100.

As shown in FIG. 9(b), a first electrode 21 in the LCD 120 includes a V-shaped opening portion 23 in which the continuous opening pattern 20 includes both of the first, linear component 22a and the second linear component 22b. The pixel has a rectangular shape having a longer side in the column direction. In the first electrode 21, six V-shaped opening portions 23 are arranged with an axis parallel to the longer side as an axis of symmetry.

The continuous opening pattern 20 in the first electrode 21 includes a plurality of V-shaped opening portions 23, and also includes a linear opening portion 24 extending in a direction by which the interior angle of the V-shaped opening portion 23 is divided into two equal parts. The linear opening portion 24 is parallel to the longer side of the first electrode 21. The linear opening portion 24 is coupled to the center of the plurality of V-shaped opening portions 23.

The continuous opening pattern 20 of the first electrode 21 further includes a minute opening portion 25a formed in the vicinity of the center of the V-shaped opening portion 23. The minute opening portion 25a acts so as to stabilize the orientation of liquid crystal molecules in the vicinity of the center of the V-shaped opening portion 23. The continuous opening pattern 20 has a minute opening portion 25b formed in the vicinity of the edge of the first electrode 21. The minute opening portion 25b acts so as to stabilize the orientation of liquid crystal molecules in the vicinity of the edge of the first electrode 21.

As shown, in FIG. 9(c), on the side of a liquid crystal layer of a second electrode 41, a dielectric projecting pattern 44 as a second domain regulating structure is formed. The dielectric projecting pattern 44 has seven third linear components 44a (downward to the right by 45°) and seven fourth linear components 44b (downward to the left by 45°). Among them, six third linear components 44a and six fourth linear components 44b are directly coupled, thereby forming six V-shaped dielectric protrusions 45. As shown in FIG. 9(c), the seven third linear components 44a and the seven fourth linear components 44b are arranged parallel to the six first linear components 22a and the six second linear components 22b in an alternating manner. Between them, four kinds of liquid crystal domains (see FIG. 2(a)) are formed.

As described above, in the case where the pixel has a rectangular shape, if the V-shaped opening portion 23 and the V-shaped dielectric protrusion 45 are arranged with the axis parallel to the longer side as an axis of symmetry, the orientation of liquid crystal molecules in the pixel can be efficiently controlled. In other words, separation into small equal regions can be easily performed as compared with the case where the V-shaped opening portion 23 and the V-shaped dielectric protrusion 45 are arranged with the axis parallel to the shorter side as an axis of symmetry.

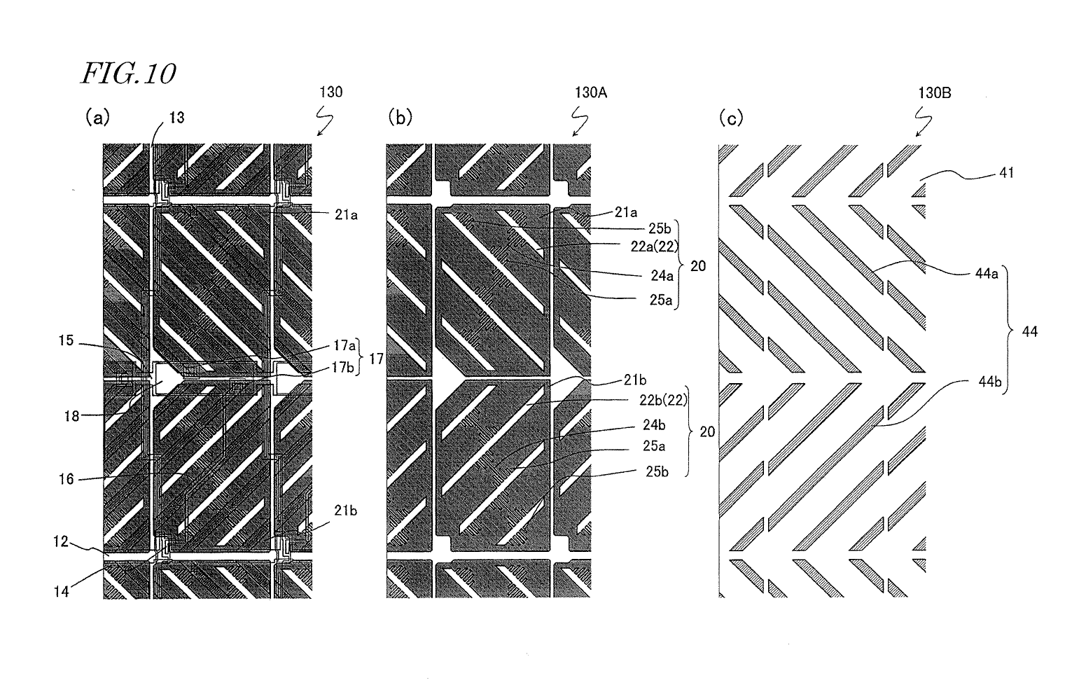

Next, with reference to FIG. 10, the pixel configuration of an LCD 130 in another embodiment of the present invention will be described. FIG. 10(a) is a plan view showing the configuration of one pixel in the LCD 130. FIG. 10(b) is a plan view showing a continuous opening pattern 20 formed in a first substrate 130A. FIG. 10(c) is a plan view showing a dielectric projecting pattern 44 formed on a second substrate 1308.

The pixel of the LCD 130 is also a normal pixel. However, the pixel includes two first electrodes 21a and 21b, as shown in FIG. 10(a). Both of the first electrodes 21a and 21b are connected to a drain of one TFT 14 via contact holes 17a and 17b, so that the same voltage is supplied. In addition, a CS bus line 15 is common to the two first electrodes 21a and 21b. Thus, the pixel structure is not a multi-pixel structure.

As shown in FIG. 10(b), the continuous opening pattern 20 of the first electrode 21a has a first linear component 22a, but does not have a second linear component 22b. The continuous opening pattern 20 of the first electrode 21b has the second linear component 22b, but does not have the first linear component 22a, contrary to the opening pattern 20 of the first electrode 21a.

The continuous opening pattern 20 of the first electrode 21a has four first linear components 22a. They are coupled by linear coupling opening portions 24a extending in a direction different from the first linear components 22a by about 90°. The continuous opening portion 20 of the first electrode 21b has four second linear components 22b. They are coupled by linear coupling opening portions 24b extending in a direction different from the second linear components 22b by about 90°. Both of the continuous opening patterns 20 include a minute opening portion 25a formed in the vicinity of the linear coupling opening portions 24, and a minute opening portion 25b formed in the vicinity of the edges of the first electrodes 21a and 21b.

A triangular notch is formed between the first electrode 21a and the first electrode 21b. This acts so as to stabilize the orientation of liquid crystal molecules, similarly to the notch 21t shown in FIG. 6(b). The notch may be omitted.

As shown in FIG. 10(c), the dielectric projecting pattern 44 in a region corresponding to the first electrode 21a has five third linear components 44a, and the dielectric projecting pattern 44 in a region corresponding to the first electrode 21b has five fourth linear components 44b. As shown in FIG. 10(a), the five third linear components 44a and the five fourth linear components 44b are arranged in parallel with the four first linear components 22a and the four second linear components 22b in an alternating manner. Between them, four kinds of liquid crystal domains (see FIG. 2(a)) are formed. Between adjacent pixels, positions of the opening pattern 22 and the dielectric projecting pattern 44 are slightly shifted.

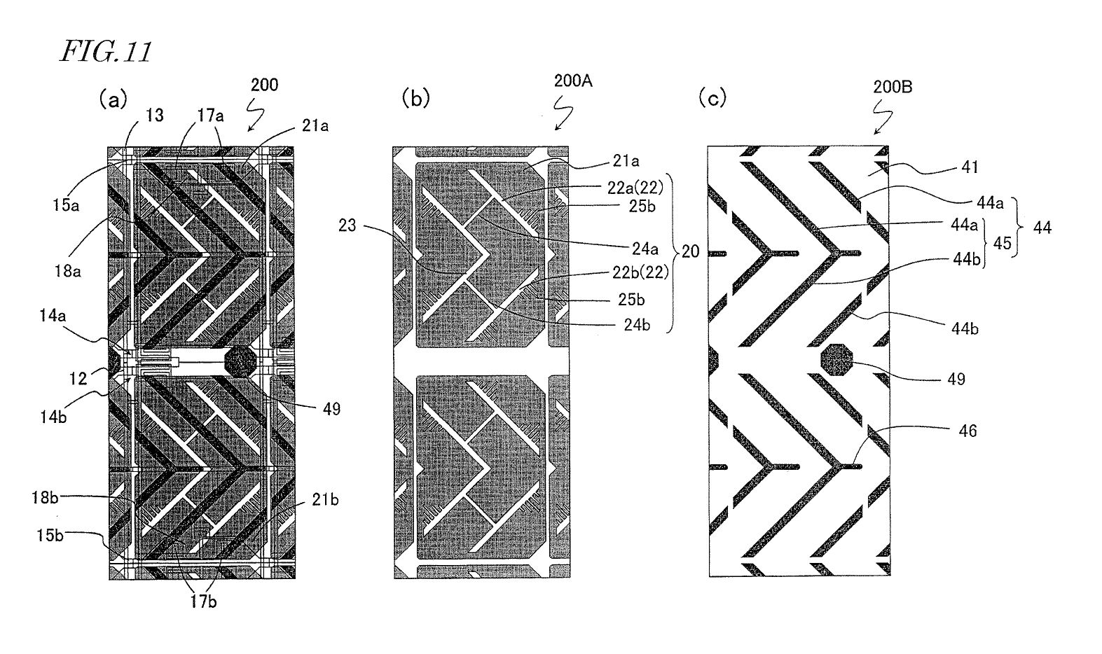

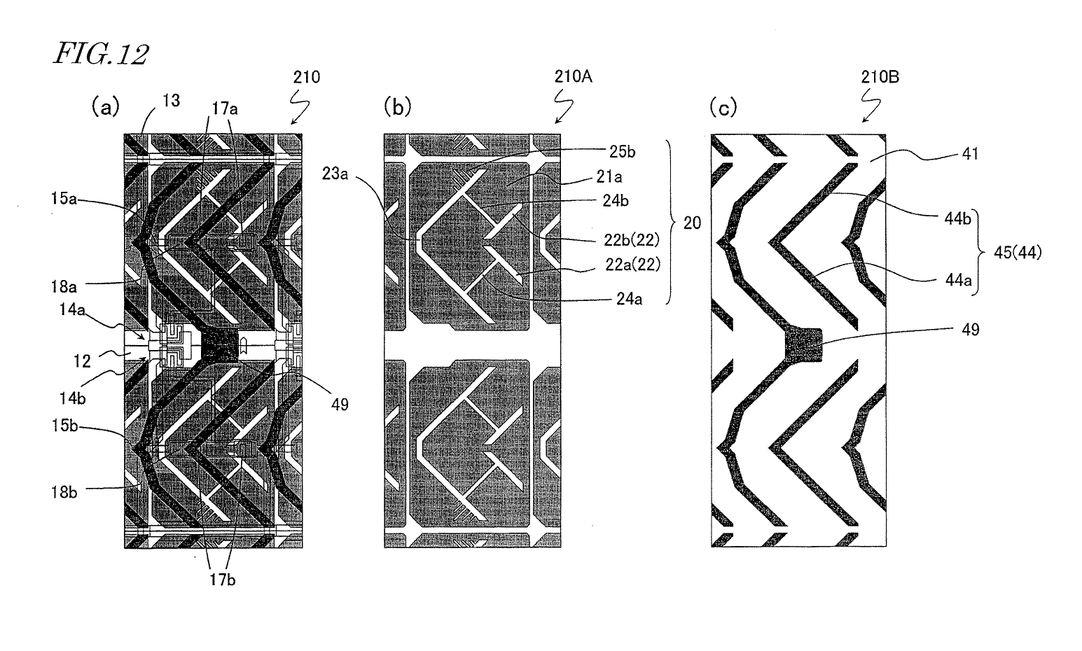

Next, with reference to FIG. 11, the pixel configuration of in an LCD 200 in still another embodiment of the present invention will be described. FIG. 11(a) is a plan view showing the configuration of one pixel of the LCD 200. FIG. 11(b) is a plan view showing a continuous opening pattern formed in a first substrate 200A. FIG. 11(c) is a plan view showing a dielectric projecting pattern 44 formed on a second substrate 200B.

The pixel of the LCD 200 has a multi-pixel structure. As shown in FIG. 11(a), the pixel has two first electrodes 21a and 21b which are connected to a common source bus line 13 via respectively corresponding TFTs 14a and 14b. The ON/OFF control of the TFTs 14a and 14b is performed by a common gate bus line 12 located between the first electrode 21a and the second electrode 21b. The first electrodes 21a and 21b are connected to drains of the corresponding TFTs 14a and 14b through contact holes 17a and 17b, respectively. CS bus lines 15a and 15b are mutually independent. Between the CS bus lines and CS counter electrodes 18a and 18b, CS capacitances are formed, respectively. The pixel of the LCD 200 is represented by the equivalent circuit shown in FIG. 4, and can be driven by the method described with reference to FIG. 5.

A columnar spacer (also referred to as a photo spacer) 49 is located on the gate bus line 12 located between the first electrode 21a and the first electrode 21b.

As shown in FIG. 11(b), the first electrode 21a has two first linear components 22a and two second linear components 22b. One pair of them forms a V-shaped opening portion 23. The two first linear components 22a are mutually coupled via a linear coupling opening portion 24a. The two second linear components 22b are mutually coupled via a linear coupling opening portion 24b. The first electrodes 21a and 21b also include minute opening portions 25b formed in the vicinity of the edges thereof.

The first electrodes 21a and 21b are symmetrically disposed with respect to the gate bus line 12. The two continuous opening patterns 20 of the first electrodes 21a and 21b have a line symmetric relationship with the gate bus line 12 as an axis of symmetry. The columnar spacer 49 disturbs the orientation of neighboring liquid crystal molecules, but the provision of the columnar spacer 49 on the gate bus line 12 which is generally formed from a light-shielding material can reduce the influence on display. The provision of the columnar spacer 49 between the first electrodes 21a and 21b having the line symmetric structure can make the influence on the display to be equal.

As shown in FIG. 11(c), the dielectric projecting pattern 44 also has a line symmetric characteristic with respect to the gate bus line 12. A region of the dielectric projecting pattern 44 corresponding to the first electrode 21a has three third linear components 44a, and a region of the dielectric projecting pattern 44 corresponding to the first electrode 21b has three fourth linear components 44b. In addition, the dielectric projecting pattern 44 has a linear dielectric protrusion 46 extending toward the superior angle from the pointed portion of the V shape of the V-shaped dielectric protrusion 45. The linear dielectric protrusion 46 acts so as to stabilize the orientation of liquid crystal molecules in the vicinity of the pointed portion of the V shape of the V-shaped dielectric protrusion 45.

As shown in FIG. 11(a), the three third linear components 44a and the three fourth linear components 44b are arranged in parallel with the two first linear components 22a and the two second linear components 22b in an alternating manner. Between them, four kinds of liquid crystal domains (see FIG. 2(a)) are formed.

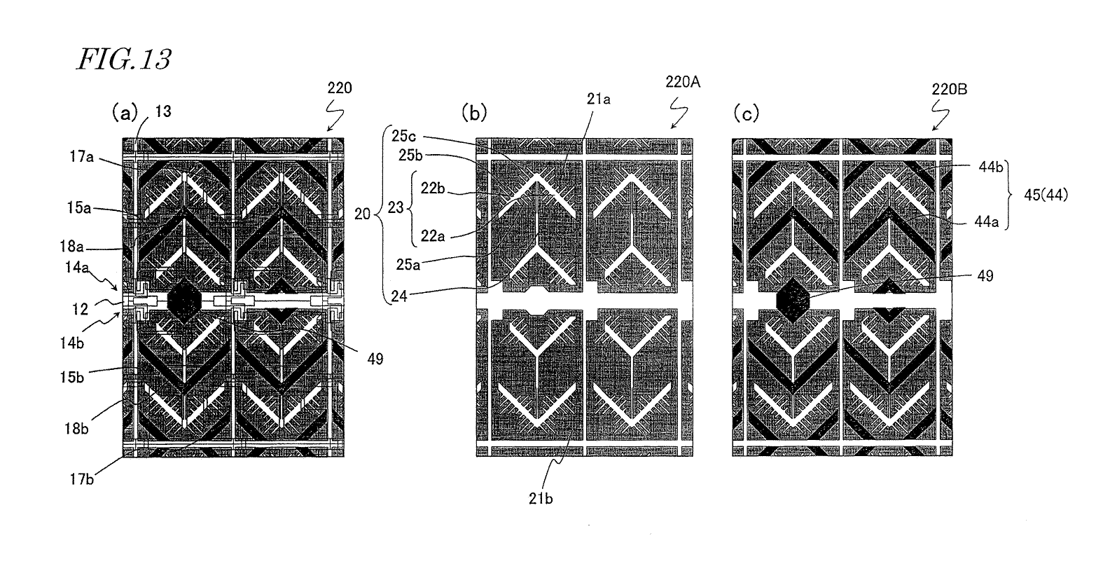

Next, with reference to FIG. 12, the pixel configuration of an LCD 210 in still another embodiment of the present invention will be described. FIG. 12(a) is a plan view showing the configuration of one pixel in the LCD 210. FIG. 12(b) is a plan view showing a continuous opening pattern formed in a first substrate 210A. FIG. 12(c) is a plan view showing a dielectric projecting pattern 44 formed on a second substrate 210B.

The pixel in the LCD 210 also has, similarly to the pixel in the LCD 200, the multi-pixel structure which is represented by the equivalent circuit shown in FIG. 4, and can be driven by the method described with reference to FIG. 5. Two CS bus lines 15a and 15b are located so as to cross the respective first electrodes 21a and 21b in the vicinity of the center thereof.

As shown in FIG. 12(b), the first electrode 21a has two first linear components 22a and two second linear components 22b. One pair of them forms a V-shaped opening portion 23a. The V-shaped opening portion 23a has a flat tip portion. The two first linear components 22a are mutually coupled via a linear coupling opening portion 24a, and the two second linear components 22b are mutually coupled via a linear coupling opening portion 24b. There is a minute opening portion 25b formed in the vicinity of the edges of the first electrodes 21a and 21b.

The first electrodes 21a and 21b are located in a symmetric manner with respect to the gate bus line 12. The continuous opening pattern in the two first electrodes 21a and 21b has a line symmetric relationship with the gate bus line 12 as an axis of symmetry. Each of the continuous opening patterns 20 has a line symmetric character with the respectively corresponding CS bus line 15a or 15b as an axis of symmetry.

As shown in FIG. 12(c), the dielectric projecting pattern 44 also has the line symmetric character with respect to the gate bus line 12. The dielectric projecting pattern 44 in a region corresponding to the first electrode 21a has two V-shaped dielectric protrusions 45. The left one of the V-shaped dielectric protrusions 45 in FIG. 12(c) has a linear portion 44d having a larger angle from the horizontal direction than the fourth linear component 44b between the fourth linear component 44b and the third linear component 44a, and a linear portion 44c having a larger angle from the horizontal direction than the fourth linear component 44b between the third linear component 44a and the fourth linear component 44b. A columnar spacer 49 is formed on the gate bus line 12, and formed integrally with the dielectric projecting pattern 44.

The columnar spacer 49 may disturb the orientation liquid crystal molecules in the vicinity thereof, but the provision of the columnar spacer 49 on the gate bus line 12 which is generally formed from a light shielding material can reduce the influence on the display. In addition, the provision between the first electrodes 21a and 21b having the line symmetric structure can make the influence on the display to be equal.

Next, with reference to FIG. 13, the pixel configuration of an LCD 220 in still another embodiment of the present invention will be described. FIG. 13(a) is a plan view showing the configuration of two pixels in the LCD 220. FIG. 13(b) is a plan view showing a continuous opening pattern 20 formed in a first substrate 220A. FIG. 13(c) is a plan view showing a dielectric projecting pattern 44 formed on a second substrate 220B.

The LCD 220 has, similarly to the pixel of the LCD 210, the multi-pixel structure which is represented by the equivalent circuit shown in FIG. 4 and can be driven by the method described with reference to FIG. 5. The two CS bus lines 15a and 15b are located so as to cross the respective first electrodes 21a and 21b in the vicinity of the center thereof, respectively.

As shown in FIG. 13(b), the first electrode 21a has two first linear components 22a and two second linear components 22b which are directly coupled, thereby forming two V-shaped openings 23. The pixel has a rectangular shape having a longer side in the column direction. The two V-shaped opening portions 23 included in the first electrode 21a are disposed with the axis parallel to the longer side as an axis of symmetry. The two V-shaped opening portions 23 are mutually coupled via a linear opening portion 24 which extends in a direction for dividing the interior angle of the two V-shaped opening portions 23 into two equal parts. The linear opening portion 24 is coupled to the center of the two V-shaped opening portions 23.

The first electrodes 21a and 21b are located in a symmetric manner with respect to the gate bus line 12. The continuous opening patterns 20 of the two first electrodes 21a and 21b are in the line symmetric relationship with the gate bus line 12 as an axis of symmetry. The V-shaped opening portions 23 included in the two first electrodes 21a and 21b are located in such a manner that the upper side (the expanded side) of the V shape is directed to the gate bus line 12. In other words, the V shape, a virtual extending line extending in a direction in which the V shape is spread from the V shape, and the gate bus line 12 constitute an isosceles triangle having the bending portion of the V shape as its apex. The apex angle of the two isosceles triangles is a right angle, so as to form a regular tetragon.

To the V-shaped opening portion 23, the minute opening portions 25a, 25b, and 25c are coupled. The minute opening portion 25a is formed in the vicinity of the linear coupling portion 24, and acts so as to stabilize the orientation of liquid crystal molecules in the vicinity of the linear coupling opening portion 24. The minute opening portion 25b is formed in the vicinity of the edge of the first electrode 21, and acts so as to stabilize the orientation of liquid crystal molecules in the vicinity of the edge of the first electrode 21, similarly to the minute opening portion 25a. The minute opening portion 25c is formed on the superior angle side from the pointed portion of the V shape of the V-shaped opening portion 23, and acts so as to stabilize the orientation of liquid crystal molecules in the vicinity of the pointed portion of the V shape of the V-shaped opening portion 23. Specifically, the minute opening portion 25c has the same function as the linear dielectric protrusion 46 included in the dielectric projecting pattern 44 shown in FIG. 11(c). Since the minute opening portion 25c is positioned in the vicinity of the edges of the first electrodes 21a and 21b, the minute opening portion 25c also acts so as to stabilize the orientation of liquid crystal molecules in the vicinity of the edges.

As shown in FIG. 13(c), the dielectric projecting pattern 44 has a V-shaped dielectric protrusion 45 including a third linear component 44a (downward to the right by 45°) and a fourth linear component 44b (downward to the left by 45°). As shown in FIG. 13(a), the V-shaped dielectric protrusion 45 is located between the two V-shaped opening portions 23, and between them, four kinds of liquid crystal domains (see FIG. 2(a)) are formed.

As described above, if the plurality of V-shaped opening portions 23 and the V-shaped dielectric protrusion 45 are located with an axis parallel to the longer side of the pixel as an axis of symmetry, it is possible to attain an advantage that the degree of freedom in the arrangement of the contact holes 17a and 17b can be increased. In addition, the degree of freedom in the location of the columnar spacer 49 can be increased. As shown in FIG. 13(c), the shape of the columnar spacer 49 when viewed from a direction perpendicular to the substrate is matched with the dielectric projecting pattern 44, so as to stabilize the orientation of liquid crystal molecules in the vicinity of the columnar spacer 49.

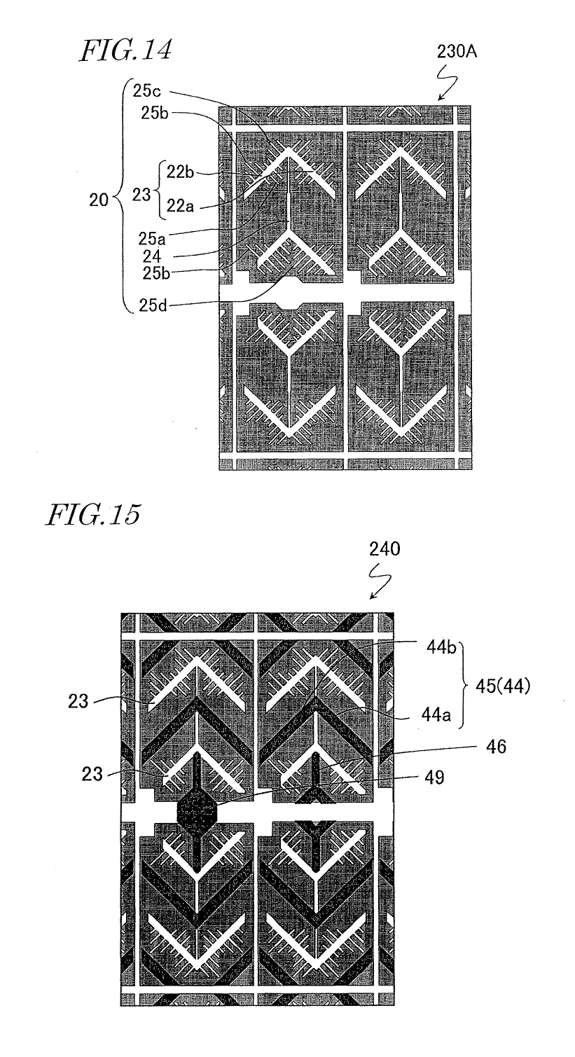

FIG. 14 shows a continuous opening pattern 20 formed in a first substrate 230A which is used instead of the first substrate 220A in the LCD 220 shown in FIG. 13.

In the continuous opening pattern 20 shown in FIG. 14, a minute opening portion 25d is formed on the interior side of the V shape on the side closer to the gate bus line 12 in the two V-shaped opening portions 23 arranged in the column direction. The minute opening portion 25d acts so as to stabilize the orientation of liquid crystal molecules on the inside of the V-shaped opening portions 23.

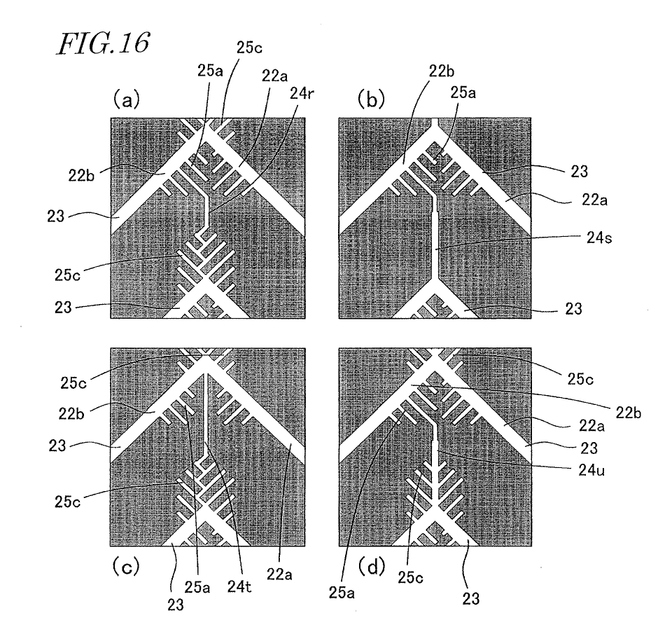

FIG. 15 shows a dielectric projecting pattern 44 in the LCD 240 in which the second substrate 220B in the LCD 220 shown in FIG. 13 is changed. The dielectric projecting pattern 44 in the LCD 240 includes, in addition to the V-shaped dielectric protrusion 45, a linear dielectric protrusion 46 positioned on the inside of the V-shaped opening portion on the side closer to the gate bus line 12. The linear dielectric protrusion 46 acts so as to stabilize the orientation of liquid crystal molecules on the inside of the V-shaped opening portions 23, similarly to the minute opening portion 25d shown in FIG. 14.

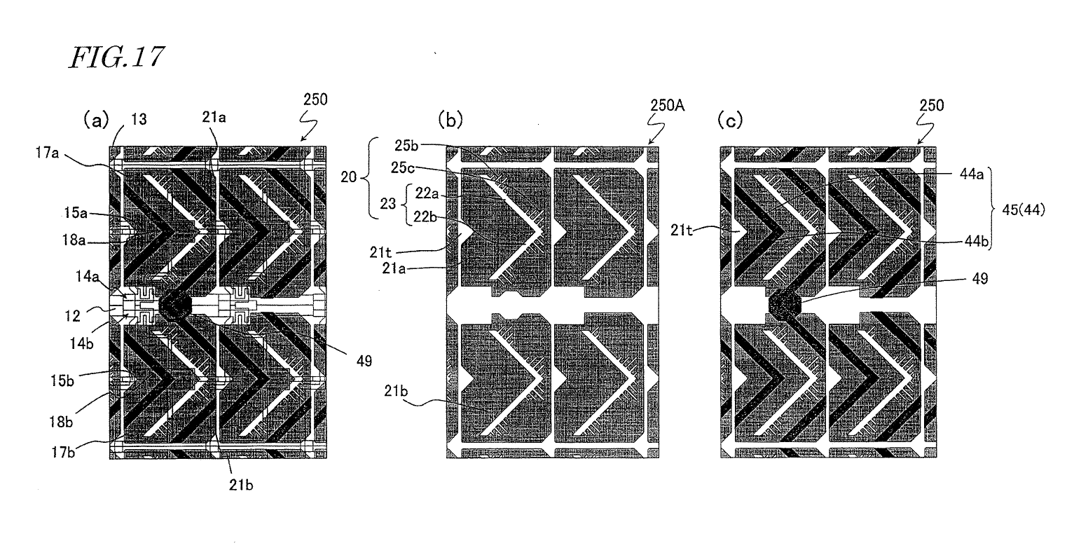

FIG. 16(a) to FIG. 16(d) show exemplary variations of the coupling portion for coupling the V-shaped opening portions 23.

In the opening pattern shown in FIG. 16(a), part of the minute opening portion 25c formed on the superior angle side from the pointed portion of the V shape of the lower one of the V-shaped opening portions 23 is coupled to one of the minute opening portions 25a formed on the inside of the upper one of the V-shaped opening portions 23 via a linear coupling opening portion 24r.

In the opening pattern shown in FIG. 16(b), the linear coupling opening portion 24s extending on the superior angle side from the pointed portion of the V shape of the lower one of the V-shaped opening portions 23 is coupled to one of the minute opening portions 25a formed on the inside of the upper one of the V-shaped opening portions 23.

In the opening pattern shown in FIG. 16(c), the top end portion of the minute opening portion 25c formed on the superior angle side from the pointed portion of the V shape of the lower one of the V-shaped opening portions is coupled to the center portion of the upper one of the V-shaped opening portions 23 via a linear coupling opening portion 24t.

In the opening pattern shown in FIG. 16(d), a linear coupling opening portion 24u formed on the superior angle side from the pointed portion of the V shape of the lower one of the V-shaped opening portions 23 is coupled to one of the minute opening portions 25a formed on the inside of the upper one of the V-shaped opening portions 23. Part of the minute opening portion 25c formed on the superior angle side of the pointed portion of the lower one of the V-shaped opening portion 23 is coupled to a linear coupling opening portion 24u.

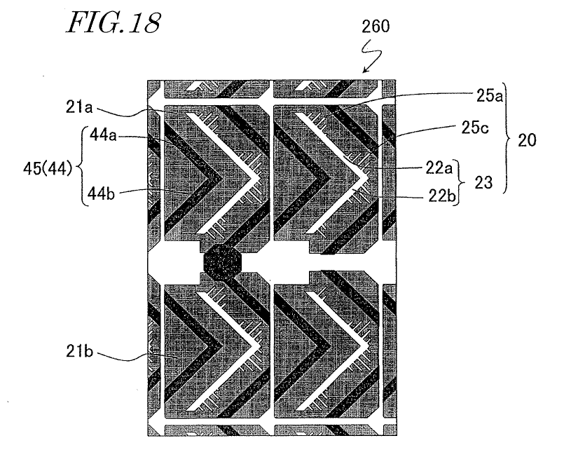

With reference to FIG. 17, the pixel configuration of an LCD 250 in still another embodiment of the present invention will be described. FIG. 17(a) is a plan view showing the configuration of two pixels in the LCD 250. FIG. 17(b) is a plan view showing a continuous opening pattern 20 formed in a first substrate 250A. FIG. 17(c) is a plan view showing a dielectric projecting pattern 44 formed on a second substrate.

The LCD 250 has, similarly to the pixel of the LCD 210, the multi-pixel structure which is represented by the equivalent circuit show in FIG. 4 and can be driven by the method described with reference to FIG. 5. Two CS bus lines 15a and 15b are located so as to cross the respective first electrodes 21a and 21b in the vicinity of the respective centers thereof.

As shown in FIG. 17(b), the first electrode 21a has one first linear component 22a and one second linear component 22b which are mutually and directly coupled, thereby forming one V-shaped opening portion 23. The pixel has a rectangular shape having a longer side in the column direction. The one V-shaped opening portion 23 included in the first electrode 21a is located with an axis parallel to the shorter side as an axis of symmetry. To the V-shaped opening portion 23, minute opening portions 25b and 25c are coupled.

At the left edge in the vicinity of the center in the column direction of the first electrodes 21a and 21b, a notch 21t having a side parallel to the V-shaped opening portion 23 is formed, so as to stabilize the orientation of liquid crystal molecules in the vicinity of the notch 21t.

The first electrodes 21a and 21b are located in a symmetry manner with respect to the gate bus line 12. The continuous opening patterns 20 of the two first electrodes 21a and 21b have the line symmetric relationship with the gate bus line 12 as an axis of symmetry.

As shown in FIG. 17(c), the dielectric projecting pattern 44 in a portion corresponding to the first electrode 21a has two third linear components 44a (downward to the right by 45°), and two fourth linear components 44b (downward to the left by 45°). One pair of them is directly coupled, thereby forming one V-shaped dielectric protrusion 45. As shown in FIG. 17(a), the two third linear components 44a and the two fourth linear components 44b are arranged in parallel with one first linear component 22a and one second linear component 22b in an alternating manner. Between them, four kinds of liquid crystal domains (see FIG. 2(a)) are formed.

As shown in FIG. 17(a) and FIG. 17(c), the columnar spacer 49 is formed on the gate bus line 12, and formed (integrally) so as to overlap the pointed portion of the V shape of the V-shaped dielectric protrusion 45.

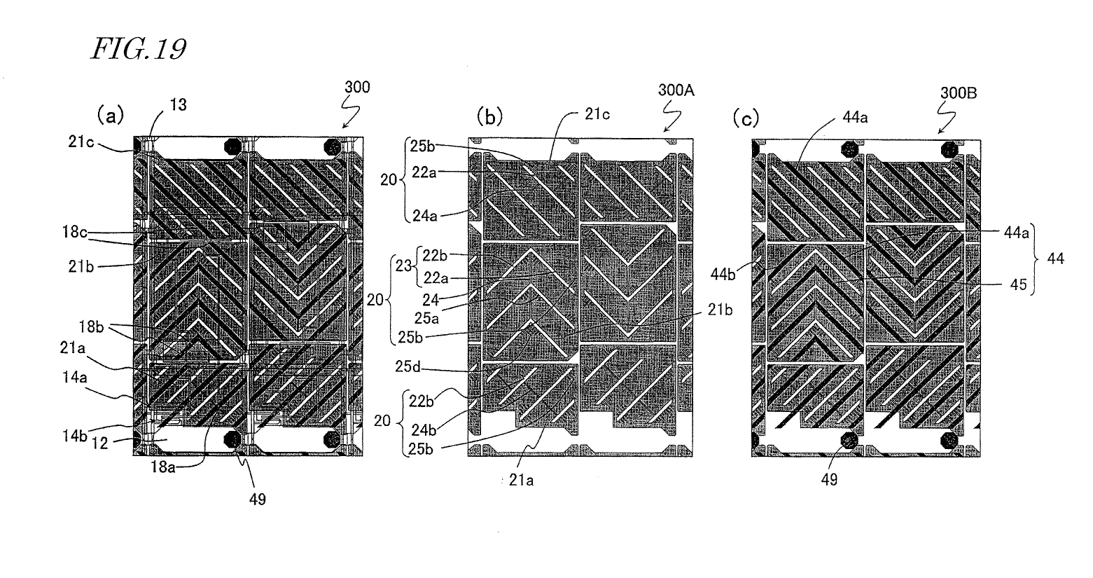

With reference to FIG. 18, shapes of the first electrodes 21a and 21b in an LCD 260 in which the first substrate 250A in the LCD 250 shown in FIG. 17 is changed will be described. The first electrodes 21a and 21b in the LCD 260 shown in FIG. 18 are different from the first electrodes 21a and 21b in the LCD 250 shown in FIG. 17 in that the notch 21t is not provided at the left edge in the vicinity of the center in the column direction of the first electrode 21a. The notch 21t has a side parallel to the V-shaped opening portion 23, thereby acting so as to stabilize the orientation of liquid crystal molecules in the vicinity of the notch 21t. However, the notch 21t can be omitted as described above.

Next, with reference to FIG. 19 to FIG. 28, the configuration of an LCD in an embodiment in which one pixel has three first electrodes 21a, 21b, and 21c will be described.

With reference to FIG. 19, the pixel configuration of an LCD 300 in still another embodiment of the present invention will be described. FIG. 19(a) is a plan view showing the configuration of two pixels in the LCD 300. FIG. 19(b) is a plan view showing a continuous opening pattern 20 formed in a first substrate 300A. FIG. 19(c) is a plan view showing a dielectric projecting pattern formed on a first substrate 300B.

In the LCD 300, one pixel includes three first electrodes 21a, 21b, and 21c, and two TFTs 14a and 14b. A drain of the TFT 14a is connected to the first electrodes 21a and 21c via contact holes 18a and 18c, respectively. A drain of the TFT 14b is connected to the first electrode 21b via a contact hole 18b. The pixel of the LCD 300 has the three first electrodes 21a, 21b, and 21c, but the first electrodes 21a and 21c are equivalent. Thus, the pixel can actually be represented by the equivalent circuit shown in FIG. 4, and can be driven by the method described with reference to FIG. 5. For example, a sub-pixel including the first electrodes 21a and 21c is a dark sub-pixel, and the sub-pixel including the first electrode 21b is a light sub-pixel.

As shown in FIG. 19(b), the continuous opening pattern 20 included in the first electrode 21b has three V-shaped opening portions 23 each including both of a first linear component 22a and a second linear component 22b. The three V-shaped opening portions 23 are located with an axis parallel to the longer side of the pixel as an axis of symmetry. To each of the V-shaped opening portions 23, a minute opening portion 25a and a minute opening portion 25b are coupled. The three V-shaped opening portions 23 are coupled by a linear opening portion 24 extending in a direction by which the interior angle of the V-shaped opening portion 23 is divided into two equal parts. The linear opening portion 24 is coupled to the center of the V-shaped opening portion 23. The continuous opening pattern 20 included in the first electrode 21b has a minute opening portion 25a formed in the vicinity of the linear coupling opening portion 24 and a minute opening portion 25b formed in the vicinity of an edge of the first electrode 21b. In addition, in the lowest V-shaped opening portion 23, a minute opening portion 25d is formed on the inner side (on the inferior-angle side) of the V shape.

On the other hand, the continuous opening pattern 20 of the first electrode 21a has the first linear component 22a, but does not have a second linear component 22b. The continuous opening pattern 20 of the first electrode 21c has the second linear component 22b, but does not have the first linear component 22a, contrary to the continuous opening pattern 20 of the first electrode 21a.

The continuous opening pattern 20 of the first electrode 21a has four first linear components 22a, which are coupled by means of a linear coupling opening portion 24a extending in a direction different from the first linear components 22a by about 90°. The continuous opening pattern 20 of the first electrode 21c has four second linear components 22b, which are coupled by means of a linear coupling opening portion 24b extending in a direction different from the first linear component 22b by about 90°. Both of the continuous opening patterns 20 have minute opening portions 25b formed in the vicinity of the edges of the first electrodes 21a and 21c, respectively.

As shown in FIG. 19(c), the dielectric projecting pattern 44 in a region corresponding to the first electrode 21b has four third linear components 44a and four fourth linear components 44b. Among them, three pairs are directly coupled, thereby forming three V-shaped dielectric protrusions 45. The four third linear components 44a and the four fourth linear components 44b are arranged in parallel with the three first linear components 22a and the three second linear components 22b in an alternating manner. Between them, four kinds of liquid crystal domains (see FIG. 2(a)) are formed.

The dielectric projecting pattern 44 in a region corresponding to the first electrode 21a has five third linear components 44a, and the dielectric projecting pattern 44 in a region corresponding to the first electrode 21c has five fourth linear components 44b. The five third linear components 44a and the five fourth linear components 44b are arranged in parallel with the fourth first linear components 22a and the four second linear components 22b in an alternating manner. Between them, four kinds of liquid crystal domains (see FIG. 2(a)) are formed.

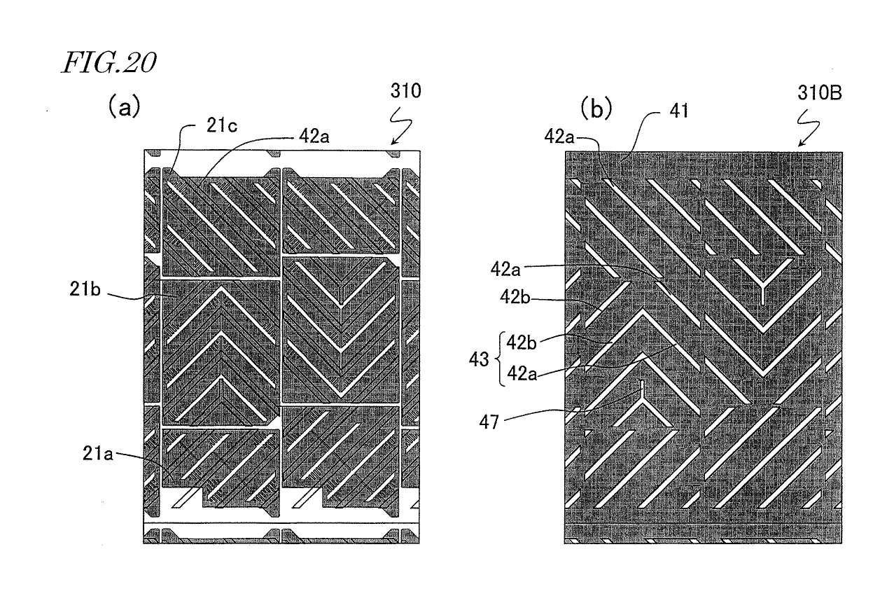

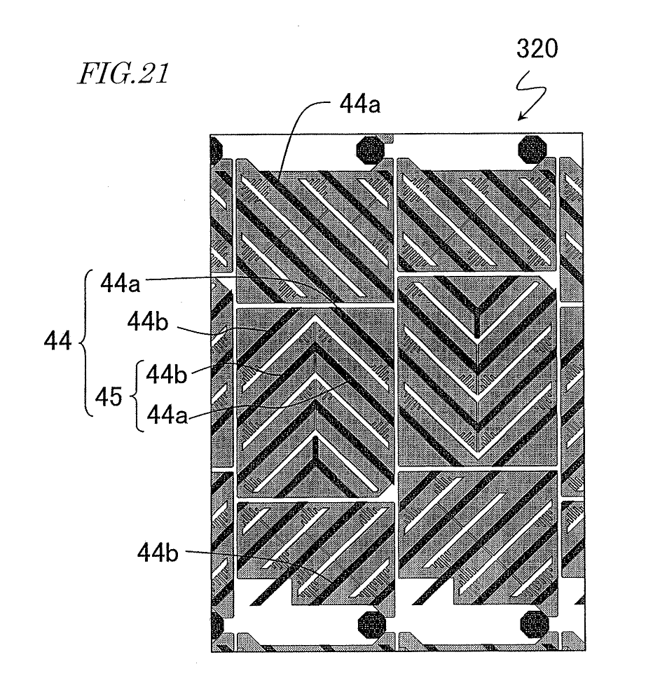

Next, with reference to FIG. 20, the pixel configuration of an LCD 310 in still another embodiment of the present invention will be described. FIG. 20(a) is a plan view showing the configuration of two pixels in the LCD 310, and is a plan view showing a continuous opening pattern 20 and an opening pattern 42. FIG. 20(b) is a plan view showing a dielectric projecting pattern 44 formed on a second substrate 310B.

The LCD 310 has an opening pattern 42 instead of the dielectric projecting pattern 44 formed on the second substrate in the LCD 300. The opening pattern 42 has a third linear component 42a, a fourth linear component 42b, and a V-shaped opening portion 43 formed by directly coupling them.

The opening pattern 42 formed in a second electrode 41 of the second substrate 310B in the LCD 310 has a linear opening portion 47 extending toward the superior angle side from the pointed portion of the V shape of the lowest V-shaped opening portion 43. The linear opening portion 47 acts so as to stabilize the orientation of liquid crystal molecules on the inside of the V shape of the V-shaped opening portion 23 instead of the minute opening portion 25d formed on the inner side (on the inferior angle side) of the V shape of the lowest V-shaped opening portion 23 in the LCD 300. The continuous opening pattern 20 included in the first substrate of the LCD 310 is the same excluding the configuration that the minute opening portion 25d formed on the inside (on the inferior angle side) of the V shape of the lowest V-shaped opening portion 23 of the continuous opening pattern 20 in the LCD 300 is not included.

With reference to FIG. 21, the pixel configuration of an LCD 320 in still another embodiment of the present invention will be described. FIG. 21 is a plan view showing a dielectric projecting pattern 40 in the LCD 320. The dielectric projecting pattern 44 has the same pattern as the opening pattern 42 formed in the second electrode 41 shown in FIG. 20. As described above, the dielectric projecting pattern as the second domain regulating structure formed in the second substrate and the opening pattern are equivalent, so that either of them can be adopted.

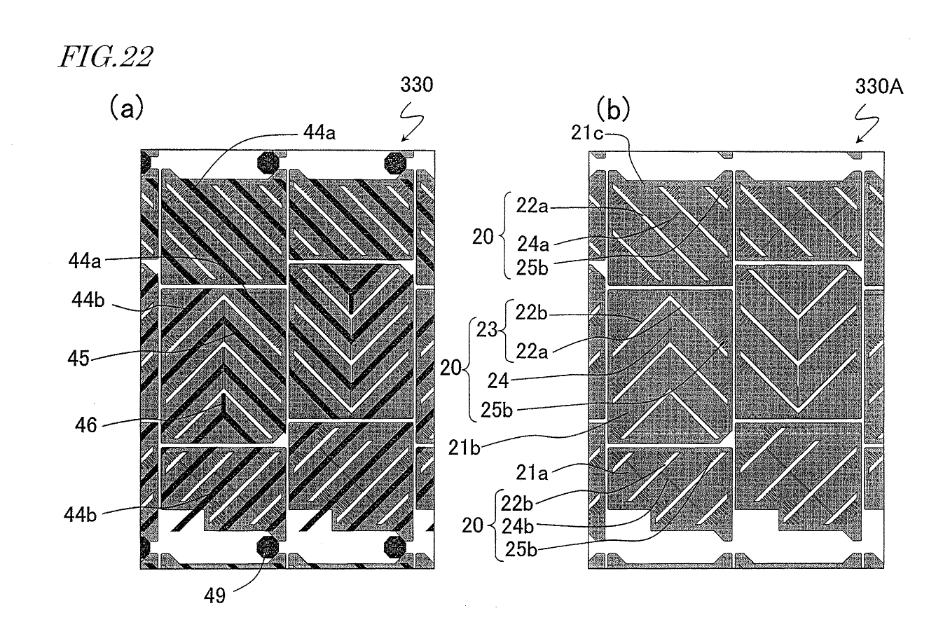

With reference to FIG. 22, the pixel configuration of an LCD 330 in still another embodiment of the present invention will be described. FIG. 22(a) is a plan view showing a continuous opening pattern 20 and a dielectric projecting pattern 44. FIG. 22(b) is a plan view showing a continuous opening pattern 20 formed in a first substrate 330A.

The continuous opening pattern 20 in the LCD 330 corresponds to the continuous opening pattern 20 in the LCD 300 shown in FIG. 19 in which the minute opening portions 25a and 25d are omitted. The dielectric projecting pattern 44 of the LCD 330 has a linear dielectric protrusion 46 extending toward the superior angle side from the pointed portion of the V shape of the lowest V-shaped dielectric protrusion 45, in addition to the dielectric projecting pattern 44 of the LCD 300.

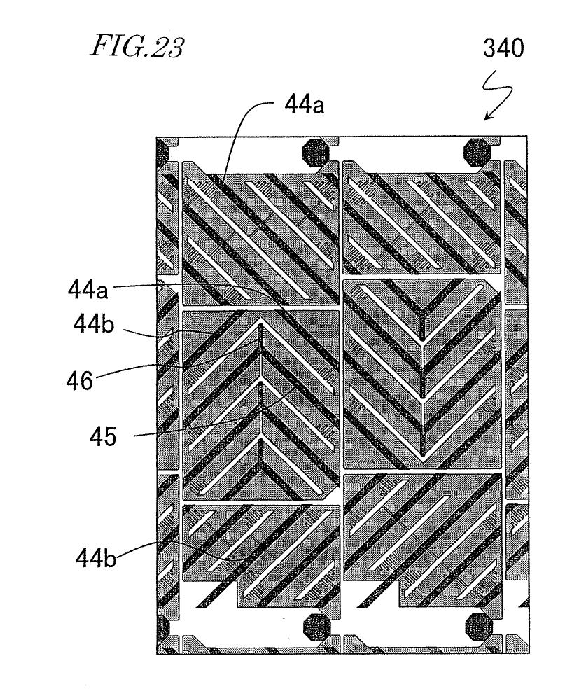

With reference to FIG. 23, the pixel configuration of an LCD 340 in still another embodiment of the present invention will be described. FIG. 23 is a plan view showing a continuous opening pattern 20 and a dielectric projecting pattern 44 in the LCD 340. The continuous opening pattern 20 included in the LCD 340 is the same as the continuous opening pattern 20 in the LCD 330 shown in FIG. 22(b). The dielectric projecting pattern 44 included in the LCD 340 is different from the dielectric projecting pattern 44 in the LCD 330 in that the dielectric projecting pattern 44 included in the LCD 340 has linear dielectric protrusions 46 extending on the superior angle side from the pointed portions of the V shapes of all of the V-shaped dielectric protrusions 45.

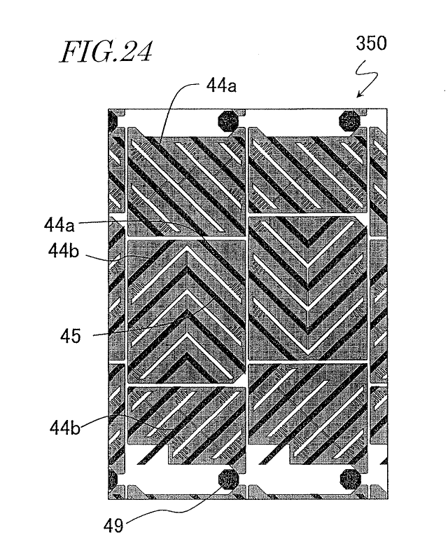

With reference to FIG. 24, the pixel configuration of an LCD 350 in still another embodiment of the present invention will be described. FIG. 24 is a plan view showing a continuous opening pattern 20 and a dielectric projecting pattern 44 in the LCD 350. The continuous opening pattern 20 included in the LCD 350 is the same as the continuous opening pattern 20 in the LCD 330 shown in FIG. 22(b). The dielectric projecting pattern 44 included in the LCD 350 is the same as the dielectric projecting pattern in the LCD 300B shown in FIG. 19(c). As described above, the minute opening portions 25a, 25c, and 25d and the linear dielectric protrusion 46 for stabilizing the orientation of liquid crystal molecules in the vicinity of the V-shaped opening portion 23 and the V-shaped dielectric protrusion 45 may be omitted.

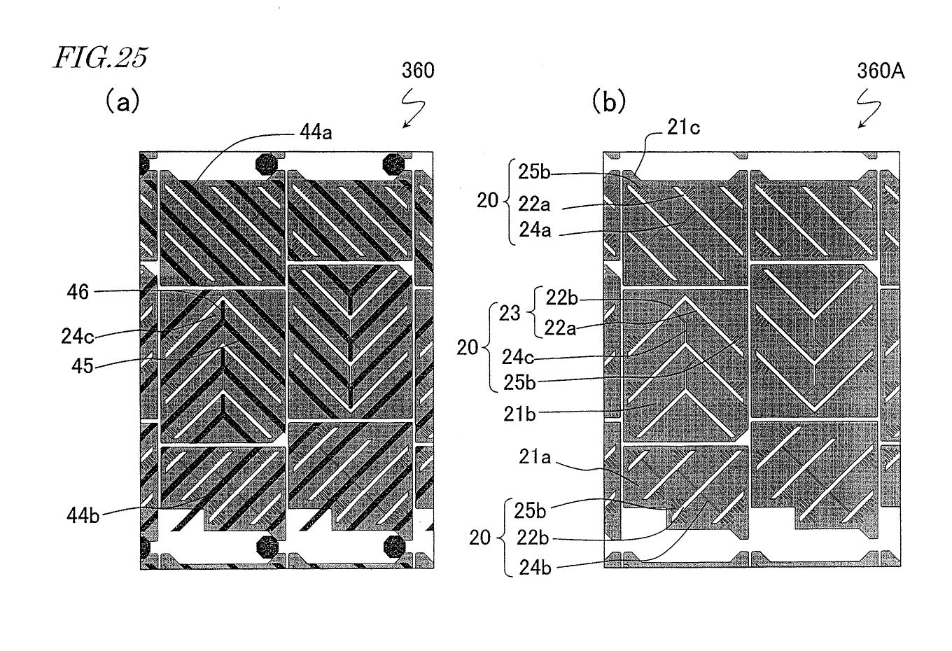

With reference to FIG. 25, the pixel configuration of an LCD 360 in still another embodiment of the present invention will be described. FIG. 25(a) is a plan view showing a continuous opening pattern 20 and a dielectric projecting pattern 44. FIG. 25(b) is a plan view showing the continuous opening pattern 20.

If the linear dielectric protrusions 46 extending toward the superior angle side from the pointed portions of V shapes of all of the V-shaped dielectric protrusions 45 are provided as in the dielectric projecting pattern included in the LCD 340 shown in FIG. 23, the upper two linear dielectric protrusions 46 overlap the linear coupling opening portion 24. The orientation of liquid crystal molecules by the linear dielectric protrusions 46 is not matched with the orientation of liquid crystal molecules by the linear coupling opening portion 24, so that there is a possibility that the orientation of liquid crystal molecules in this region may be largely disturbed.

The LCD 360 shown in FIG. 25 has the dielectric projecting pattern 44 which is the same as that in the LCD 340 shown in FIG. 23, but the shape of the coupling opening portion 24c of the continuous opening pattern 20 is different from that of the linear coupling opening portion 24 in the LCD 340. Specifically, the coupling opening portion 24c of the continuous opening pattern 20 in the LCD 360 is bent so as not to overlap the linear dielectric protrusion 46 formed in the corresponding position. By adopting such a configuration, the above-described disturbance in orientation of liquid crystal molecules can be suppressed.

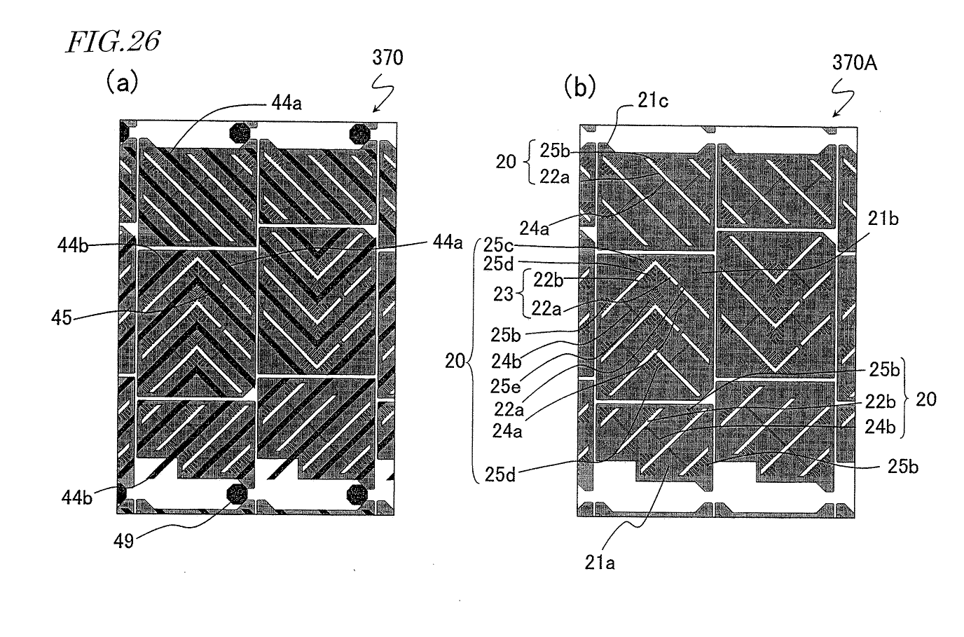

With reference to FIG. 26, the pixel configuration of an LCD 370 in still another embodiment of the present invention will be described. FIG. 26(a) is a plan view showing a continuous opening pattern 20 and a dielectric projecting pattern 44. FIG. 26(b) is a plan view showing the continuous opening pattern 20.

The dielectric projecting pattern 44 included in the LCD 370 is the same as the dielectric projecting pattern 44 in the LCD 350 shown in FIG. 24, so that the linear dielectric protrusion 46 extending toward the superior angle side from the pointed portion of the V shape is not included.

The continuous opening pattern 20 included in the first electrodes 21a and 21c of the LCD 370 is the same as the continuous opening pattern 20 included in the LCD 350 shown in FIG. 24.

The continuous opening pattern 20 included in the first electrode 21b of the LCD 370 is different from the continuous opening pattern 20 included in the first electrode 21b of the LCD 350 in that the V-shaped opening portion 23 is segmented in one position of the first linear component 22a. In the first linear component 22a, the segmented portion from the V-shaped opening portion 23 is shown as a linear component 22e.

The continuous opening pattern 20 included in the first electrode 21b of the LCD 370 does not have the linear coupling opening portion 24 which is coupled to the center of the V-shaped opening portion 23, but has a linear coupling opening portion 24a for coupling adjacent two first linear components 22a and a linear coupling opening portion 24b for coupling adjacent two second linear components 22b. In addition, a minute opening portion 25c is included on the superior angle side of the pointed portion of the V-shaped opening portion 23, and a minute opening portion 25d is included on the inside (on the inferior angle side) of the V-shaped opening portion 23.

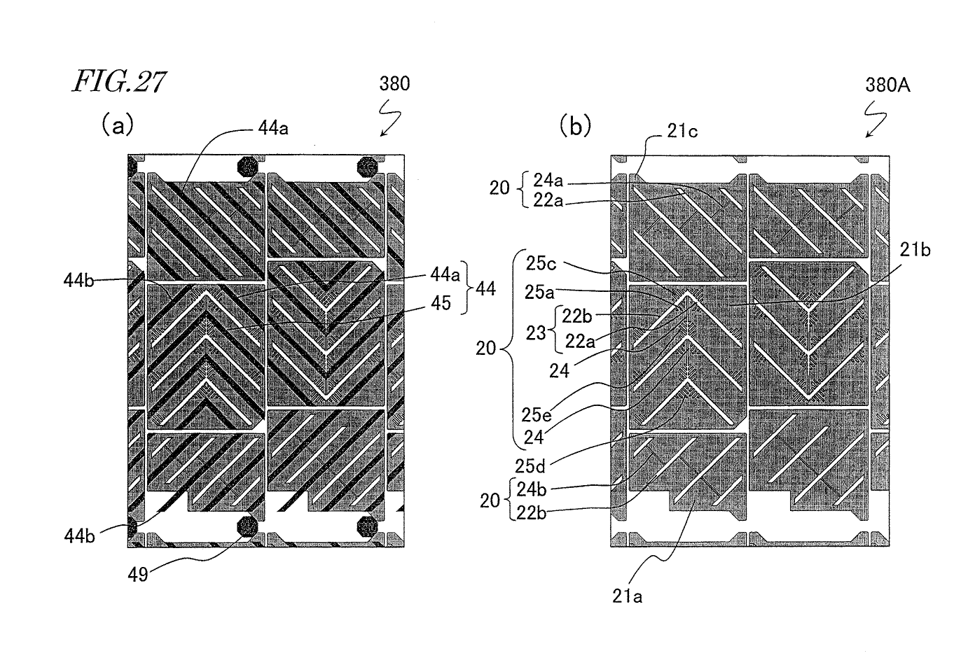

With reference to FIG. 27, the pixel configuration of an LCD 380 in still another embodiment of the present invention will be described. FIG. 27(a) is a plan view showing a continuous opening pattern 20 and a dielectric projecting pattern 44. FIG. 27(b) is a plan view showing the continuous opening pattern 20 included in a first substrate 380A.

The dielectric projecting pattern 44 included in the LCD 380 is the same as the dielectric projecting pattern 44 in the LCD 350 shown in FIG. 24, so as not to have the linear dielectric protrusion 46 extending toward the superior angle side from the pointed portion of the V shape.

The continuous opening patterns 20 included in the first electrodes 21a and 21c of the LCD 380 are different from the continuous opening pattern 20 included in the LCD 350 shown in FIG. 24 in that the minute opening portion 25b is not included.

The continuous opening pattern 20 included in the first electrode 21b of the LCD 380 is different from the continuous opening pattern 20 included in the first electrode 21b of the LCD 350 shown in FIG. 24 in that the minute opening portion 25e coupled to the linear coupling opening portion 24 is included, in that the minute opening portion 25c is included on the superior angle side of the pointed portion of the V-shaped opening portion 23, and in that the minute opening portion 25d is included on the inferior angle side of the pointed portion of the V-shaped opening portion.

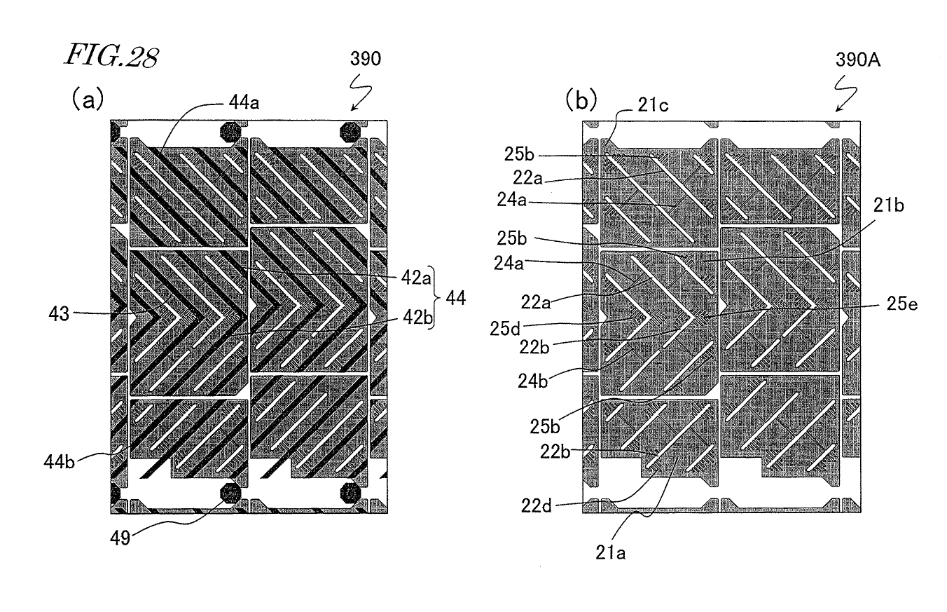

With reference to FIG. 28, the pixel configuration of an LCD 390 in still another embodiment of the present invention will be described. FIG. 28(a) is a plan view showing a continuous opening pattern 20 and a dielectric projecting pattern 44. FIG. 28(b) is a plan view showing a continuous opening pattern 20 included in a first substrate 390A.

The continuous opening patterns 20 of the first electrodes 21a and 21c in the LCD 390 are the same as the continuous opening patterns 20 of the first electrodes 21a and 21c in the LCD 380 shown in FIG. 27, but different from the continuous opening pattern 20 included in the first electrode 21b.

The continuous opening pattern 20 of the first electrode 21b in the LCD 390 has three first linear components 22a and three second linear components 22b. Among them, two pairs are mutually directly coupled, so as to form two V-shaped opening portions 23. The pixel has a rectangular shape having a longer side in the column direction. The two V-shaped opening portions 23 are located with an axis parallel to the shorter side as an axis of symmetry. The second linear component 22b of one of the V-shaped opening portions 23 is segmented into two portions.

The continuous opening pattern 20 of the first electrode 21b in the LCD 390 does not have the linear coupling opening portion 24 coupled to the center of the V-shaped opening portion 23, but has a linear coupling opening portion 24a for coupling adjacent two first linear components 22a and a linear coupling opening portion 24b for coupling adjacent two second linear component 22b. In addition, a minute opening portion 25e is included on the superior angle side of the pointed portion of the V-shaped opening portion 23, and a minute opening portion 25d is included on the inside (on the inferior angle side) of the V-shaped opening portion 23.

As described above, in the MVA LCD in respective embodiments of the present invention, since the first electrodes 21, 21a, 21b, and 21c have continuous opening portions (continuous opening patterns 20), respectively, the MVA LCD has a characteristic that it is possible to obtain a larger number of separated portions than the prior art in a smaller number of cutting positions than the prior art. As understood from the above-described exemplary LCDs in various embodiments, various combinations can be realized, and the combinations are not limited to those exemplarily and specifically described.

As exemplarily described in the embodiments, in order to suppress the disturbance in orientation of liquid crystal molecules in the vicinity of the V-shaped opening portion 23 or the V-shaped dielectric protrusion 45 (the V-shaped opening portion 43), the linear dielectric protrusion 46 (the linear opening portion 47) may be provided, or the minute opening portions 25a, 25c, 25d, or 25e may be provided. It is noted that the minute opening portion 25a or the like has a 2-dimensional shape, so that it is possible to attain an advantage that it is hardly affected by an error of alignment as compared with the case where the linear dielectric protrusion 46 (the linear opening portion 47) is provided. The same is true for the minute opening portion 25d provided for the edge of the second electrode 41, and it is possible to attain an advantage that it is hardly affected by an error of alignment as compared with the case where a linear protrusion parallel to the edge as described in Patent Document 1.

### INDUSTRIAL APPLICABILITY

The present invention is applied to an MVA liquid crystal display device.

### REFERENCE SIGNS LIST

12 Gate bus line
13 Source bus line
14 TFT
15 CS bus line
16 Drain lead-out wiring
17 Contact hole
18 CS counter electrode
20 Continuous opening pattern
21 First electrode (Pixel electrode)
22 Opening portion
22a First linear component
22b Second linear component
23 V-shaped opening portion
24 Linear coupling opening portion
41 Second electrode (Counter electrode)
42 Opening pattern in second electrode
43 V-shaped opening portion
44 Dielectric projecting portion
44a Third linear component
44b Fourth linear component
45 V-shaped dielectric protrusion

1. An MVA liquid crystal display device comprising: a first substrate; a second substrate; a vertical-alignment type liquid crystal layer disposed between the first substrate and the second substrate; a first domain regulating structure formed in the first substrate; and a second domain regulating structure formed in the second substrate,
the first domain regulating structure having a first linear component extending in a first direction and a second liner component extending in a second direction different from the first direction by about 90°,
the second domain regulating structure having a third linear component extending in the first direction and a fourth linear component extending in the second direction,
the number of at least one of the first and second linear components or the third and fourth linear components being plural, when viewed from a normal direction to the first substrate, the first linear component and the third linear component being alternately arranged, the second linear component and the fourth linear component being alternately arranged, and when a voltage is applied across the liquid crystal layer of an arbitrary pixel, four domains of which tilting directions of liquid crystal molecules are mutually different by about 90° being formed between the first linear component and the third linear component and between the second linear component and the fourth linear component, wherein
the arbitrary pixel includes at least one first electrode formed in the first substrate and a second electrode formed in the second substrate, each of the at least one first electrode has a continuous opening pattern, and the first and second linear components of the first domain regulating structure are included in any of the continuous opening patterns included respectively in the at least one first electrode.

2. The liquid crystal display device of claim 1, wherein the at least one first electrode includes a first type of first electrode in which the continuous opening pattern includes a V-shaped opening portion including both of the first and the second linear components.

3. The liquid crystal display device of claim 2, wherein the continuous opening pattern of the first type of first electrode includes a plurality of both of the first and the second linear components, and includes a plurality of V-shaped opening portions.

4. The liquid crystal display device of claim 3, wherein the continuous opening pattern of the first type of first electrode further includes a linear opening portion extending in a direction by which an interior angle of the V-shaped opening portion is divided into two equal parts.

5. The liquid crystal display device of claim 4, wherein the first type of first electrode has a longer side and a shorter side, and the linear opening portion is parallel to the longer side.

6. The liquid crystal display device of claim 5, wherein the linear opening portion is coupled to the center of the plurality of V-shaped opening portions.

7. The liquid crystal display device of claim 2, wherein the at least one first electrode further includes a plurality of minute opening portions parallel to a direction substantially orthogonal to the first linear component or the second linear component.

8. The liquid crystal display device of claim 7, wherein the plurality of minute opening portions are formed in the vicinity of the center of the V-shaped opening portion.

9. The liquid crystal display device of claim 7, wherein the plurality of minute opening portions are formed in the vicinity of an edge of the at least one first electrode.

10. The liquid crystal display device of claim 7, wherein the plurality of minute opening portions are included in the continuous opening pattern.

11. The liquid crystal display device of claim 1, wherein the at least one first electrode includes a plurality of first electrodes, and
the plurality of first electrodes include a second type of first electrode in which the continuous opening pattern includes only either one of the first linear component or the second linear component, and a third type of first electrode in which the continuous opening pattern includes only the other one of the first linear component or the second linear component.

12. The liquid crystal display device of claim 11, wherein the continuous opening pattern of the second type of first electrode includes a plurality of the first linear components or the second linear components, and the plurality of first linear components or the plurality of second linear components are coupled by a linear coupling opening portion extending in a direction different from the first direction by about 90° or by a linear coupling opening portion extending in a direction different from the second direction by about 90°.

13. The liquid crystal display device of claim 1, wherein the plurality of first electrodes includes two first electrodes arranged symmetrically with respect to a gate bus line or a CS bus line, and
the continuous opening patterns of the two first electrodes have a line symmetric relationship with the gate bus line or the CS bus line as an axis of symmetry.

14. The liquid crystal display device of claim 13, wherein both of the two first electrodes are first type of first electrodes in each of which the continuous opening pattern includes both of the first and the second linear components, and the V-shaped opening portion is disposed in such a manner that the upper side of the V shape is directed to the gate bus line or the CS bus line.

15. The liquid crystal display device of claim 1, wherein the continuous opening pattern included in each of the at least one first electrode does not cross the edge of the at least one first electrode.

16. The liquid crystal display device of claim 1, wherein when viewed from a normal direction to the first substrate, a respective edge of the at least one first electrode partially overlaps a source bus line.

17. The liquid crystal display device of claim 1, wherein the second domain regulating structure is included in the opening pattern formed in the second electrode or the dielectric projecting pattern formed on the side of the liquid crystal layer of the second electrode.

18. The liquid crystal display device of claim 17, wherein in the at least one first electrode, the continuous opening pattern includes a V-shaped opening portion including both of the first and the second linear components, and
when viewed from a normal direction to the first substrate, the opening pattern or the dielectric projecting pattern of the second electrode further includes a linear opening portion or a linear dielectric protrusion extending in a direction for dividing an interior angle of the V-shaped opening portion into two equal parts.

19. The liquid crystal display device of claim 18, wherein when viewed from the normal direction to the first substrate, the at least one first electrode is in parallel with the linear opening portion or the linear dielectric protrusion of the second electrode extending in the direction for dividing the interior angle of the V-shaped opening portion into two equal parts, and does not have an opening portion which overlaps the linear opening portion or the linear dielectric protrusion of the second electrode.
